(19) United States
(12) Patent Application Publication
(10) Pub. No.: US 2009/0204964 A1
(43) Pub. Date: Aug. 13, 2009

(54) Distributed trusted virtualization platform

(76) Inventors: Peter F. Foley, Los Altos Hills, CA (US); Rajesh Gupta, San Diego, CA (US); Rao Cherukuri, Los Altos Hills, CA (US); Jithendra Bethur, Newark, CA (US); Brent Haines, Cupertino, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 12/287,833

(22) Filed: Oct. 14, 2008

Related U.S. Application Data
(60) Provisional application No. 60/979,728, filed on Oct. 12, 2007.
(60) Provisional application No. 60/999,056, filed on Oct. 15, 2007.

(51) Int. Cl. G06F 9/455; G06F 9/00; G06F 21/00; G06F 15/16; H04L 9/08

(52) U.S. Cl. 718/1; 713/2; 726/1; 709/202; 380/279

(57) ABSTRACT

A platform architecture shifts the networked computing paradigm from PC+Network to a system using trusted mobile internet end-point (MIEP) devices and cooperative agents hosted on a trusted server. The MIEP device can participate in data flows, arbitrate authentication, and/or participate in implementing security mechanisms, all within the context of assured end-to-end security. The MIEP architecture improves platform-level capabilities by suitably (and even dynamically) partitioning what is done at the MIEP nodes, the network, and the server based infrastructure for delivering services.

### CROSS-REFERENCE TO RELATED APPLICATION(S)

This application claims priority under 35 U.S.C. § 119(e) to U.S. Provisional Patent Application Ser. No. 60/979,728, “Distributed Trusted Virtualization Platform,” filed Oct. 12, 2007 by Peter F. Foley et al. and to U.S. Provisional Patent Application Ser. No. 60/999,056, “Distributed Trusted Virtualization Platform,” filed Oct. 15, 2007 by Peter F. Foley et al. The subject matter of all of the foregoing is incorporated herein by reference in their entirety.

### BACKGROUND OF THE INVENTION

1. Field of the Invention

This invention relates generally to virtualization of computing resources and security and trust in an environment of such virtualization.

2. Description of the Related Art

The inexorable trend towards workforce mobility and the requirement for web access while mobile is driving significant new technology development and businesses in devices and infrastructure associated with mobile web access. Of significant value is the reliable access to, and utilization of, computing services and data delivered over the web, thus making the wide-area network effectively both the computing medium as well as a heterogeneous collection of databases. All of these capabilities are delivered through a diverse group of “web services.” Technically, this poses a number of challenges related to communications, security, trust, negotiations and monitoring among diverse devices, agents, and business processes. All of this currently takes place in an environment where neither the device, the communications infrastructure, nor the web servers can be trusted, and where the communications link is highly variable in quality.

In order to improve trust in the mobile device, and to create an infrastructure upon which device capabilities can be augmented or place shifted in a trustworthy manner via virtualization, there is a need to establish a foundation of security. Consider first a typical software implementation of existing mobile devices, as shown conceptually in FIG. 1. In this implementation, the software stack is oblivious of both the capabilities and requirements posed by the wide-area networking, delegating these issues instead principally to the applications level. Consequently, the critical actions at startup happen in a manner that treats the system as a monolithic local entity consisting of local peripherals and interfaces: the system boots from PROM, the kernel is loaded, followed by the OS. Applications are then layered and run “on top of” (hosted by) the OS in the same system address space. It is therefore easy for applications to observe or (maliciously) affect other applications running at the same time. Security provisions are added as a post hoc modification by providing differentiation among access capabilities: e.g., user versus kernel mode. Since the semantic information for such differentiation exists only at higher layers of the software stack, the underlying hardware memory system can easily be manipulated by an application to foil such differentiated privileges, for instance, by strategically placing data/code in a uniformly addressed memory model.

Consequently, even though applications are generally executed in the “user” mode, in the current architecture that intention can be subverted and it is possible for applications to run code at a higher priority level in kernel mode, or for viruses that infect an application to access kernel mode privileges. Viruses have used techniques such as introducing kernel mode VxDs or using tricks such as the call gate mechanism to run code at higher privilege levels.

Modern anti-malware software is also engineered as an application program or installed as a post hoc modification to a running operating environment. This means, to be successful, such a software must win the race with a malicious application program in terms of time when it is installed, in the observability of important system events and actions and the level of access storage and state information. Thus, if a virus “rootkits” the system by executing beneath the OS or even the kernel, it can be difficult for anti-malware software to detect it as the malware has control of system resources generally employed by the anti-malware to detect it. A rootkitted system is shown conceptually in FIG. 2.

Furthermore, web services provide a means to expose and use programming interfaces on wide area networks, potentially with many mobile devices. By design, these interfaces are lightweight to enable portability across platforms with diverse computational capabilities. For example, HTTP is a session-free, non-transactional protocol that was originally designed for transporting documents. Later, with the advent of styling innovations and its separation from the data content, it also provided a simple, usable UI for running applications over the web. HTTP works well when the client platform can provide the computing power and form-factor necessary to render the UI in a reliable and predictable way.

The ubiquity of web servers, server software, supporting programming languages and libraries, and supporting technology such as XML has made HTTP a good protocol for distributed applications. In essence, the use of web technologies has evolved from a user-to-computer technology, to one that supports (and is widely adopted for) computer-to-computer interactions, essentially using HTTP as a transport for Remote Procedure Calls (RPC) between distinct (and often geographically separate) components of an application.

From a functional standpoint, the evolutionary changes to web services had primarily been focused around the client. Clients have gone through the following transitions:
Client computers (desktops and laptops) running browsers that simply render HTML as served by the service architecture.
Server computers running software that uses Web Services as an integration mechanism; effectively transferring data and control as a part of a larger application.
Client computers handling more (or all) complex (thick-client) rendering and formatting logic for unformatted XML data retrieved using HTTP from the Web Server using technologies like AJAX.
Mobile devices accessing the Web Services and Sites (such as online-banking, maps and navigation, local search, etc) that have become a common part of life for consumers.

While these changes have had an impact on the format of data served up by Web Services, the architectural drivers for Web Services and Web Server Software have remained the same. These generally are
Reliability—Web Services preferably should be up all the time. The consumer expectation is that these services never go down for any reason.
Transportability—Web Services preferably should be accessible from any Endpoint the user employs with (wherever possible) no change in functional experience.
Scalability—Web Services preferably should be able to handle simultaneous requests from many (sometimes millions of) clients in a quick and responsive way.

FIG. 3 illustrates the most common approach for meeting the design drivers for building Web Services. The major aspects are described below:
Redundancy—Each server is redundant and can handle requests that are initiated from any supported client. This approach typically includes geographic redundancy as depicted with the inclusion of Service Site 1 and Service Site 2. This provides for scalability as well as reliability.
Tiered Distribution—Each aspect of the Web Service deployment is handled in a dedicated tier, enabling it to be scaled according to demand and suitability to task. For example, there are generally more Web Servers in a large scale Web Service deployment because a) they handle SSL encryption and requisite key generation and b) they are exposed to the Internet and most vulnerable to malicious attacks, including denial of service attacks.
Load Balancing—The use of redundancy should be transparent to the client. This essentially means that a single internet target must be presented for a connection that can then be redirected to the next available server. Balancing across web servers usually requires dedicated load-balancing hardware. Balancing across other tiers is generally built into the software platform upon which they are implemented. Balancing across sites is generally done via a simple DNS round-robin algorithm or simple correlation for either locale of the trunk IP assignment.
Replication—Most current Web Service architectures provide complete redundancy for all aspects of the system, including the data services tier. There is no single point of failure. This requires that dedicated connections are set up and utilized to replicate persistent information between servers.

This architecture provides widely available, large-scale Web Services that can be accessed by any standard Web-based client. It can provide for information and service requests from a large number of clients anywhere in the world. This standard architecture does not, however, address the security and privacy requirements/challenges in current mobile devices, particularly given the current trends in mobile device usage. These requirements/challenges include:
Inadequate mobile Endpoint device security
Inadequate mobile Endpoint device authentication
Inadequate Anonymity/Privacy on the Web
Inadequate Trust in Web Services
Lack of a Trustworthy Agent Hosting Environment

Thus, there is a need for innovations in mobile devices and/or the supporting infrastructure to address some or all of these needs.

### BRIEF DESCRIPTION OF THE DRAWINGS

FIG. 1 (prior art): Typical Software Stack in Current Mobile Devices

FIG. 2 (prior art): Rootkitted System Software Block Diagram

FIG. 3 (prior art): Existing Web Server Software Architectures

FIG. 4 (prior art): Trusted Platform Module (TPM) Block Diagram

FIG. 5: Trusted Boot via Transitive Trust Mechanism

FIG. 6: Mobile Device Software Architecture Block Diagram

FIG. 7: Alternative Mobile Device Software Architecture

FIG. 8: Multi-Radio Virtualized Broadband Pipe

FIG. 9: MTM Embodiment Block Diagram

FIG. 10: MTM Mediated Trusted Boot Block Diagram

FIG. 11: Secure Cryptographic Link between MTM and Server

FIG. 12: Visual Attestation: Secure Login Example in Multi-Window Environment

FIG. 13: Visual Attestation: Trust Bar Example in Full Screen Mode

FIG. 14: Virtual Services Architecture

FIG. 15: Ideal Trusted Agent Server Implementation

FIG. 16: Utilizing the MTM to Provide Trust to an Untrusted Platform

FIG. 17: OS Hosted Virtualized Service Server Implementation

FIG. 18: TVMM Based Agent Master

FIG. 19: P2P Agent Communications Architecture—Physical View

FIG. 20: P2P Agent Communications Architecture—Logical View

FIG. 21: Example MIEP/Trusted Server Relationship

FIG. 22: AIK Certificate Generation Protocol Example

FIG. 23: Attestation Protocol Diagram Example

### DETAILED DESCRIPTION OF THE PREFERRED EMBODIMENTS

TABLE of Contents

| I. Foundational Elements: Platform Security | | 10 |
|---|---|---|
| | I.A. The Mobile Internet End-Point Device (MIEP) as an | 10 |
| | Integral Component of a Mobility Focused System | |
| | I.B. Trusted Computing Group (TCG) Secure Architecture Model | 12 |
| | I.C. Transitive Trust and Trusted Boot | 15 |
| | I.D. Virtual Machine Monitor (VMM) | 16 |
| | I.E. Trusted Virtual Machine Monitor (TVMM) | 17 |
| II. The Mobile Device Software Architecture | | 19 |
| III. Communications Channel Virtualization | | 20 |
| IV. Mobile Trust Module (MTM) | | 23 |
| | IV.A. Physical Implementations | 23 |
| | IV.B. Achieving Trusted Boot from the MTM | 24 |
| | IV.C. MTM Based Software Environment | 26 |
| | IV.D. User Authentication in the MTM/HMD Combination | 27 |
| | IV.E. MTM Status Indicators and Control Buttons | 27 |
| | IV.F. MTM as HMD Malware Scanning Locus | 27 |
| V. The Server in Support of the MIEP Model | | 28 |
| | V.A. Ideal Server Supports Protected Capabilities, Roots of Trust, | 29 |
| | and a Trusted Boot Process. | |
| | V.B. VMs on the Server Support VMs on the MIEP | 29 |
| | V.C. Spawned Server VMs Conform to an API Supporting MIEP Agents | 30 |
| | V.D. Server VM Attestation to an MIEP VM | 30 |
| | V.E. The MIEP May Specify Capabilities of Spawned VMs on the Server | 31 |
| | V.F. Server VMs Can Be Shared | 31 |
| | V.G. A TVMM Implementation Inherently has Minimal Trusted Path Issues | 31 |
| | V,H. Trust Level Indication UI - Visual Attestation | 32 |
| | V.I. Global State Cache | 36 |
| VI. Software Architecture of the Agent Services | | 37 |
| | VI.A. Virtual Services | 37 |
| | VI.B. Complete Virtualization of Services | 39 |
| | VI.C. OS Hosted Virtualization of Services | 41 |
| | VI.D. TVMM Based Agent Master | 43 |
| VII. Description of Agents and Agent Operation | | 44 |
| | VII.A. Web Browsing Agent | 44 |
| | VII.B. Web Content Filtering Agent | 45 |
| | VII.C. Malware Scanning Agent | 46 |
| | VII.D. Behavioral Monitoring Agent | 47 |
| | VII.E. P2P Agent | 47 |
| | VII.F. Data Compression and Transcoding Agent | 48 |
| | VII.G Communications Channel Virtualization Agent | 51 |
| | VII.H. Data Storage Agent | 51 |
| | VII.I. Application ViewPort Agent | 51 |
| | VII.J. MIEP Global State Cache Management Agent | 52 |
| | VII.K. Transaction Management Agents | 52 |
| | VII.L. Web Identity Broker Agent | 53 |
| VIII. Aspects of System Operation | | 53 |
| | VIII.A. Mutual Attestation | 54 |
| | VIII.B. Platform Independence - Ability to Migrate Virtual Machines | 58 |
| | VIII.C. Platform Use of Meta-Data | 58 |
| | VIII.D. Example Uses of the MIEP Trust Capabilities | 59 |
| | VIII.E. Dynamic Attestation | 62 |

### I. Foundational Elements: Platform Security

### I.A. The Mobile Internet End-Point Device (MIEP) as an Integral Component of a Mobility Focused System

The following disclosure describes, in part, a platform architecture that shifts the networked computing paradigm from PC+Network to a system using trusted Mobile Internet End-Point (MIEP) devices and cooperative Agents hosted on a Trusted Server. The MIEP device can participate in data flows, arbitrate authentication, and/or participate in implementing security mechanisms, all within the context of assured end-to-end security. The MIEP architecture improves platform-level capabilities by suitably (and even dynamically) partitioning what is done at the MIEP nodes, the network, and the server based infrastructure for delivering services.

The MIEP component of the mobility platform presented here is not a classic thin client. A classic enterprise thin client typically sits behind a “walled garden”—a corporate firewall on a dedicated high bandwidth high availability ethernet network. This facilitates booting over the network and significant compute offloading to corporate servers. Security tasks can also be offloaded to corporate servers and the non-mobile nature of these devices and their location behind a corporate firewall increases the feasibility of deploying and enforcing policies which minimize security vulnerabilities, including physical I/O modalities on the thin client devices. Trust issues are also mitigated with respect to the communications network and the server, since there is implied trust in the corporate server and network integrity.

In contrast, the MIEP, because it is mobile, may not sit behind a corporate firewall, and does not enjoy a dedicated reliable high bandwidth connection to any network. The MIEP device typically also operates on a limited energy budget (e.g., batteries) and under stringent form factor and budgetary constraints. These factors significantly alter system design optimization criteria. Optimizing the design of the MIEP requires an integrated systems level perspective as a systems optimization problem encompassing the device itself, unreliable wireless and wireline communications links, and supporting server(s) available over the web. To adequately address the requirements of an MIEP based computing model, it is highly beneficial that trust and security be afoundational element in the design of the overall system.

The example system described below provides a framework for distributed capabilities in a Service Framework that leverages existing OS (operating system) and application software on a new trust/security/virtualization model infrastructure. This is advantageous to carriers who, for example, want to be able to provide unique differentiated services instead of commoditized “dumb pipes.” In the following, we describe the approach using an example based on the context of current practice and emerging standards, although the invention is not limited to this context or this example.

### I.B. Trusted Computing Group (TCG) Secure Architecture Model

To respond to the emerging need for security in our computing infrastructure, the industry has sponsored the Trusted Computing Group (TCG) that seeks to define hardware and software requirements for security, and to drive adoption of standards to achieve secure computing platforms. TCG is also instrumental in defining a vocabulary for describing important concepts related to security and trust in computing. We find this vocabulary useful in describing our innovations and their embodiments. Where possible, we use vocabulary that is compliant with TCG recommendations or standards. The following examples are based on the TCG model and the TCG vocabulary but the invention is not limited to these specific examples or to the TCG model or to the TCG vocabulary. The TCG model is chosen as an example for convenience and for didactic purposes.

In order to provide a far more secure system than what is currently available, including protection against rootkits, a set of additional capabilities are needed by the mobile device. In the secure hardware platform architecture proposed by the TCG, these capabilities include the following:
1) Ability to define protected capabilities as a set of commands, which alone can access shielded locations
2) Integrity measurement and storage
3) Integrity reporting

I.B.1 Trusted Platform Module (TPM)

One implementation of these protected capabilities and shielded-locations used to report integrity measurements is to locate them on the mobile device motherboard in a hardware based tamper-resistant module, a Hardware Root of Trust (HROT) called the Trusted Platform Module (TPM). In the TCG implementation, the TPM incorporates a number of tamper-resistant resources, including:
1) non-volatile memory for key, platform configuration, and other data storage
2) cryptographic function/compute capability of functions such as AES (symmetric encryption), SHA-1 (secure hash), and asymmetric key pair generation
3) random number generation
4) secure clock (to prevent replay attacks, etc)

A block diagram of an example TPM is shown in FIG. 4. A more complete description of the TCG implementation of a TPM can be found at the Trusted Computing Group (TCG) website. Some of the manufacturers of TCG compliant TPMs include Atmel, ST Microelectronics, and Infineon. A datasheet for the Atmel V1.2 compliant TPM can be found at: http://www.atmel.com/dyn/resources/prod_documents/5132s.pdf, for example.

Note that the HROT need not be instantiated as a standalone hardware module, such as the TPM, but that the set of protected resources may also be realized in the core CPU chipset, or in the CPU itself.

I.B.2 Integrity Measurement and Reporting

Integrity measurement is the process of obtaining metrics of platform characteristics that affect the integrity (trustworthiness) of a platform; storing those metrics; and storing digests of those metrics in the TPM. Integrity reporting is the process of attesting to the contents of integrity storage.

In this example embodiment, the system state is stored as measurement digests in the TPM in a group of 20-byte registers called Platform Configuration Registers (PCRs). The values of these registers are formed by “extending” (typically exclusively ORing) the existing value by a new value, and then hashing (using the NIST standard hash function SHA-1) that extension to obtain a new digest and storing the 20-byte result back in the PCR. This mechanism creates a “running history/log” of all load events or system modifications that cannot be recreated out of order—the so called “ratcheting” feature. This has great value in the platform's ability to attest to its state (and how it got there). The digest mechanism also allows a single PCR register to record essentially an unlimited number of measurement events.

I.B.2 TCG Roots of Trust

In TCG systems, Roots of Trust are components that must be trusted as misbehavior may not be detected. There are three fundamental Roots of Trust in the TCG model:
1) Root of Trust for Measurement (RTM)
2) Root of Trust for Storage (RTS)
3) Root of Trust for Reporting (RTR)

In one embodiment, the RTM includes the initial BIOS boot code (located in protected non-volatile Flash Memory on the motherboard) executed on the main host processor—an ARM or x86 CPU in this particular example. The actual measurement code block resident in secure non-volatile memory is designated the Core Root of Trust for Measurement (CRTM), following the TCG nomenclature. The RTS and the RTR are both located in the TPM.

### I.C. Transitive Trust and Trusted Boot

Transitive trust, or “inductive trust” as it is also known, is the process of securely “bootstrapping” a system, one software layer at a time, where each layer, before loading the next layer, measures the code to be loaded and, using the resources of the TPM, checks the measurement against a value held in secure storage (in the TPM in this example). An important requirement of the process is that the relationships between the components be acyclic, e.g., that the boot sequence can be described using a Directed Acyclic Graph (DAG).

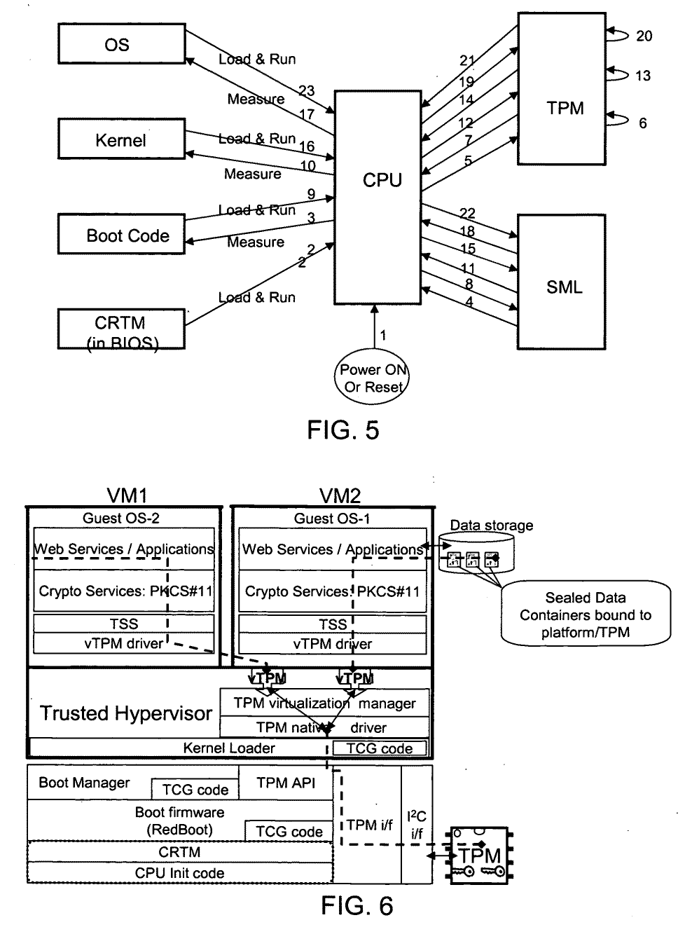

Using this methodology, a trusted boot process starting at the BIOS, and proceeding up through OS or application code level can be achieved. FIG. 5 diagrams an example trusted boot process. In FIG. 5, the process starts with Power On or a hard Reset (1), the CRTM block is read out of BIOS Flash and executed by the CPU. This CRTM block measures (hashes) the next code block (the Boot Code) (3), and retrieves from the Stored Measurement Log(SML) (4) all previous measurements that contributed to the relevant digest value (stored in a PCR in the TPM) and passes the new measurement value along with the data retrieved from the SML to the TPM (5). The TPM recreates the digest from the values obtained from the SML and if it matches that in the PCR, and the new code block measurement matches the expect value, the PCR is extended with the new measurement value (6). The affirmative validation result is provided to the CPU (7), and the measured value is stored in the SML (8) and then the Boot Code just verified is loaded and run (9). This process continues transitively “on up the chain” until the OS and/or application is loaded and run.

### I.D. Virtual Machine Monitor (VMM)

In addition to the use of an HROT, such as the TPM, and the implementation of a trusted boot process, our approach to platform security also takes advantage of virtualization methods, for it is when virtualization is tied to a HROT and integrated into a trusted boot and measurement process that virtualization becomes truly powerful from an isolation, provisioning, and flexibility standpoint We discuss the process of virtualization before as it relates to security before describing examples that combine TPM and VM.

Conventionally, a Virtual Machine Monitor (or Hypervisor) is a virtualization technique to abstract CPU resources that enable multiple operating systems to run simultaneously on the same host processor. There are several types of VMMs:
1) Those that run directly on the hardware such that any “guest OS” or other applications runs “on top of” the VMM. This is commonly referred to as a Type-1 or “on the metal” Hypervisor.
2) Those that run within an operating system allowing a “guest OS” or other application to run “above” the host OS. This is commonly referred to as a Type-2 or native OS hosted Hypervisor.

The former approach is generally more secure and provides better performance. It is in fact very difficult to provide strong security guarantees using a Type-2 Hypervisor. It is used in our example embodiment to:
1) Provide the flexibility of running multiple operating systems and/or applications (such as browsers not needing a host OS) directly on the mobile device.
2) Provide multiple independent security domains (in the form of VMs with different security status) on the mobile device.
3) Provide a uniform target environment for application software development.
4) Provide a “portable” execution environment that can be place shifted, particularly across unreliable broadband wireless links.

Virtual Machine Monitors are a good place to instrument the system for behavioral monitoring purposes as all applications go through the VMM to access hardware resources. The embodiment of the VMM utilized in the following examples is a so-called “paravirtualized” VMM (but the invention is not limited to this type of VMM) in which most code runs natively on the CPU. While this VMM approach offers high performance with minimum size and minimal CPU overhead (as low as 2-3%), it typically requires that some of the low level kernel drivers of the hosted OS be “ported” to the VMM by replacing kernel calls to drivers that modify state the VMM monitors and protects with “hypercalls” to the VMM.

### I.E. Trusted Virtual Machine Monitor (TVMM)

One weakness of a VMM from a security standpoint is that it can be still subverted by rootkit malware such as Virtual Machine Based Rootkits (VMBRs) which can be used, for example, to establish BOTnets for purposes of SPAM generation, Denial of Service (DOS) attacks, or online fraud schemes. To combat this, a VMM can leverage the protected capabilities rooted in a TPM, thus creating a Trusted VMM (TVMM—also known as a Trusted Hypervisor). The TVMM enjoys the security benefits of the TCG platform (including the Trusted Boot process) along with other improvements, including:
1) Providing applications with an execution environment of a separate dedicated tamper-resistant hardware platform while retaining the ability to run side-by-side with normal (perhaps untrusted) applications.

The ability to create “closed box” Virtual Machines (VMs) that can cryptographically identify the software they run and securely and reliably attest their state to remote parties—a capability we call “compartmented attestation”—that enables the creation of virtual trusted islands on the mobile device.

An important advantage of VMs is that it is far easier to treat them as static images (of binary representation), a static OS that can be hashed for the purposes of transitive trust and storage of VM state in a PCR digest—which ultimately allows attestation of that VM image. This is in contrast to typical OS implementations that incorporate dynamic components that can be linked/loaded/unloaded in real time.

This static, or “closed box” capability of a VM hosted OS is an important capability as it allows DRM and other transactions to occur on a VM to web based server or Peer-to-Peer (P2P) basis, and it fosters the ability of remote parties to securely and reliably provision the capabilities of VMs hosted on the mobile device.
2) The ability of “closed box” VMs to establish trusted paths between users and applications. In current VM implementations, there usually is no way for a running application hosted by a VM to know whether its inputs are coming from an authenticated human user or from a malicious program.
3) The ability for the mobile device to host a variety of Operating Systems that are optimalfor the hosted application. Operating systems tailored to an application can be smaller and simpler than general purpose OSes. Further, an OS tailored to an application can provide the optimal environment for that application from an energy, functionality, and security requirement standpoint.
4) VMs are an ideal unit of granularity upon which to apply policies or otherwise provision a given computing environment. The ability to remotely and securely provision any given VM provides powerful tools for IT management of MIEPs.

### II. The Mobile Device Software Architecture

The block diagram of FIG. 6 shows one example of the software architecture of the MIEP. As can be seen in the block diagram, this particular implementation of the software architecture includes the following primary layers:
1. A Boot layer at the lowest level that directly interfaces with the TPM and makes its capabilities available to the upper layers in a secure manner.
2. The TVMM/Trusted Hypervisor.
3. The VMs hosted by the TVMM, which in turn may host applications.

Each VM can host an Operating System (or other applications). Operating Systems in turn typically host Applications. The TPM virtualization is performed principally by the TVMM (Trusted Hypervisor). Note that the CRTM code is located directly above the CPU initialization code, and both are fetched out of protected BIOS non-volatile memory.

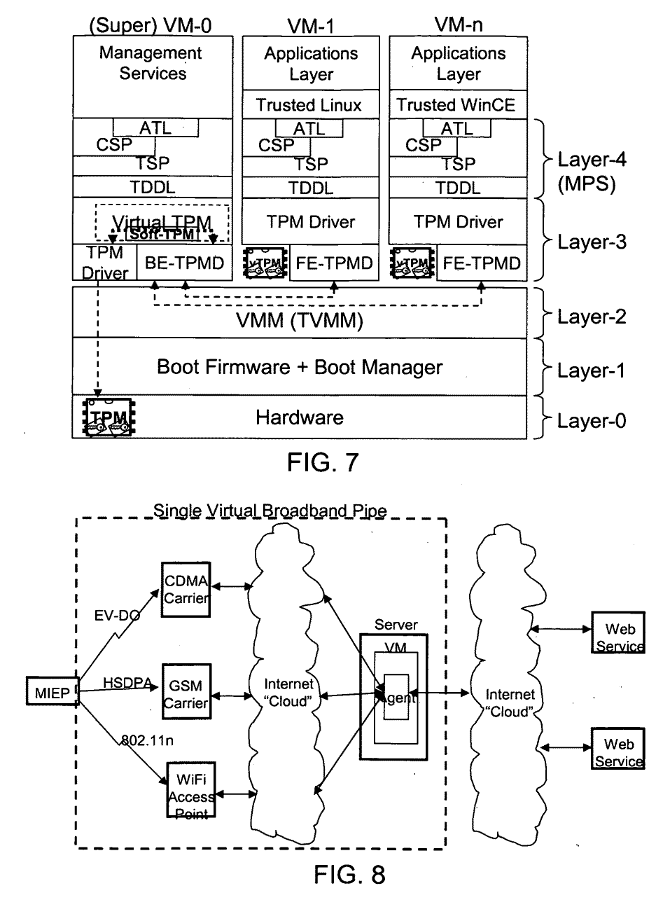

If the VMM itself does not contain I/O device driver code that is virtualized for the supported VMs, and the VMM is a “block box” that does not directly support TPM virtualization internally, then a modification to the system architecture can be advantageous. An embodiment for such a modification to the software architecture is shown in FIG. 7. In this implementation, a “Super” VM or “Console” VM is created, labeled VMO, which hosts the TPM virtualization code as well as all of the physical I/O driver code. As can be seen in the block diagram of FIG. 7, this particular implementation of the software architecture includes four primary layers:
1. A Boot layer at the lowest level that directly interfaces with the TPM and makes its capabilities available to the upper layers in a secure manner.
2. The TVMM/Trusted Hypervisor.
3. The TPM driver and TPM virtualization software.
4. The virtualization platform SDK, which is presented to applications hosted by the VMs. These services include the TPM device drive library, the TCG TSS (Trusted Software Stack), and various application trust and cryptographic services.

Layered on top of software layer 4 are the applications hosted by the VM. FIG. 7 uses the following acronyms:
ATL: Application Trust Library
CSP: Cryptographic Service Provider
TSP: TSS Service Provider
TDDL: TPM Devide Driver Library
BE-TPMD: Back-end TPM Driver
FE-TPMD: Front-end TPM Driver

### III. Communications Channel Virtualization

The proposed MIEP architecture preferably takes a broad view of the communication resources available to the device via multiple radios and networks. These communication links can be shared among applications or otherwise coordinated for improved secure and reliable delivery of web based services. One approach coalesces multiple wireless links (such as multiple cellular air interfaces, WiFi, and WiMAX) into a virtual communications channel. Virtualizing multiple links into a single virtual pipe improves diversity robustness as well as energy efficiency.

There are multiple ways energy efficiency can be improved: for instance, by having differentiated radios for the most energy efficient use for a given bit rate, radio range and protocol abstraction. The radios can be coordinated either as a “paging hierarchy” or as an aggregation of multiple simultaneous links. As an example of the former, a distinction can be made between a Low Power Radio (LPR) such as Bluetooth that provides low idle power consumption, and a High Power Radio (HPR) that provides high through capacity as a tradeoff against high idle power consumption (e.g., the WiFi). In one approach, the (always-on) LPR acts as a pager to the (normally-asleep or powered-down) HPR. The LPR radio, therefore, acts as a carrier of control information for the multi-radio communication link whereas data information is transmitted via LPR and/or HPR depending upon the throughput needs.

This idea can be extended across different radio abstractions (e.g., across cellular and WiFi links). For example, energy efficiency of VOIP delivery on smartphones can be improved by using the cellular channel to wakeup the WiFi radio for the VOIP call. WiFi can be more energy efficient for making the active call, but the cellular channel can be more energy efficient in quiescent/idle mode where it can be used as a wakeup or paging channel.

These and other results point to the fact that energy efficiency of radios and protocols is dependent upon the nature of the traffic and the application needs for performance and reliability. Multiple communication links open up a new dimension of system-level optimization to maximize connection robustness, maximize throughput, minimize latency, and minimize energy consumption for the MIEP.

We approach this optimization problem in a systematic manner by adding contextual awareness to the communication virtualization strategy. This contextual awareness information is biased based on parameters established by the user. Such parameters can include weightings for cost, bandwidth, latency, and connection reliability. The types of contextual awareness factors can include location, energy status of the MIEP, individual wireless channel link strength, and costs associated with any link at that moment (such as whether a wireless link is in “roaming” mode and is therefore more expensive). Additionally, based on past location history, one's future wireless link situation can be predicted and this information factored into the link virtualization strategy.

This type of virtual wireless link takes advantage of intelligent management at both ends of the virtual channel, and this can be facilitated through use of a Server based Agent acting on behalf of the MIEP. The situation is diagrammed in FIG. 8, which shows the multiple-links virtualized into a single pipe.

In FIG. 8, there exists a trusted Agent running on the Server which acts as the “sink” to aggregate the multiple communications links on the “Server side” of the Internet Cloud. Requests to web based services, for example, are then relayed back out over the internet by the Agent to the service provider. Note here the Internet Cloud was drawn twice (logical view) for the sake of conceptual clarity. The Agent has access to contextual information that the MIEP does not (and vice-versa), and preferably coordinates with the MIEP as to the optimum virtualization strategy.

On the MIEP side, a multi-channel link layer unification API allows apps to access the virtualized resource. Much finer grain inter-channel interactions can occur on the MIEP than at the server based Agent since it has close physical proximity to the actual communication channels.

The complete communications channel (“pipe”) virtualization subsystem is represented by the functionality contained within the dotted lined box. Note there is no reason one of the links could not be a wired link, and there is no reason that the Agent must be running in a trusted environment.

### IV. Mobile Trust Module (MTM)

### IV.A. Physical Implementations

IV.A.1 TPM Resident on MIEP Motherboard

In one embodiment, the TPM and the VMM code are resident on the MIEP motherboard. This approach offers the greatest security. However, this approach has the drawback that many existing mobile devices do not have integral Hardware Roots of Trust, such as TPMs. Further, there are practical and market barriers to installing the necessary trusted boot and VMM code on these mobile device motherboards.

IV.A.2 MTM as USB Slave

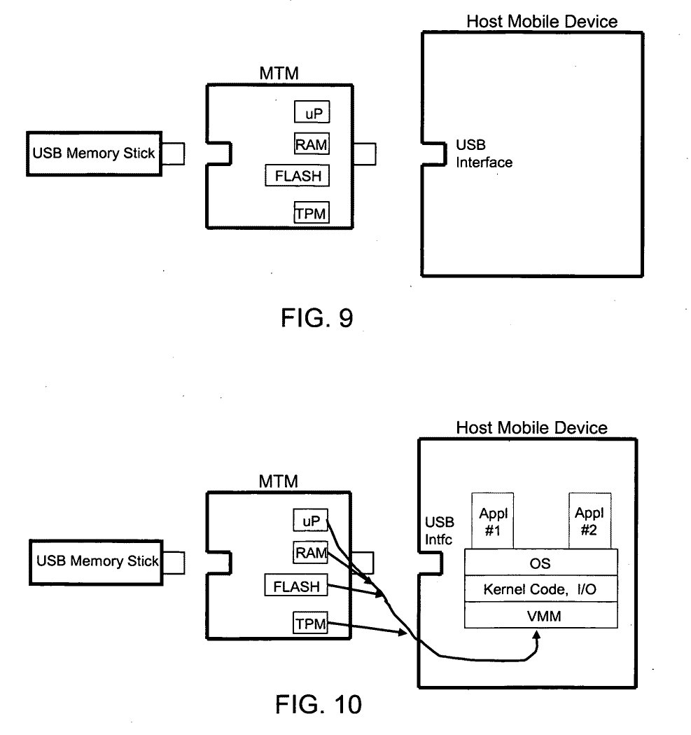

There are other alternatives that are attractive from an implementation and market penetration standpoint, particularly for markets such as Enterprise. One alternative that is especially appropriate for larger form factor mobile devices such as laptops is shown diagrammatically in FIG. 9. In this embodiment, the TPM, the VMM code, the CRTM (Core Root of Trust for Measurement), the CRTS (Core Root of Trust for Storage), and the CRTR (Core Root of Trust for Reporting) reside in a “USB Wrapper” module that fits between a USB memory stick and a Host Mobile Device (HMD). We denote the TPM equipped module the Mobile Trust Module (MTM). In this implementation, the HMD acts as a host system for the MTM, providing energy, compute, memory, and I/O resources.

There are efforts underway today to incorporate TPM type functionality onto USB memory sticks (which is yet another embodiment). However, the implementation in FIG. 9 is more efficient in that the TPM on the MTM can be amortized over a large number of USB memory sticks. Data can be stored in encrypted format over a large number of USB memory sticks, all linked to the CRTS on the MTM.

IV.A.3. MTM as USB Master

In another embodiment, similar to that diagrammed above in FIG. 9, the MTM could, in addition to USB slave operation when inserted into an HMD, operate without the HMD, and in that mode be a USB master to USB devices such as memory sticks. To support this additional capability, the MTM would incorporate a USB host controller and would incorporate the ability to supply power to the USB bus either with an internal battery, or with an external power supply that would plug into the MTM. This embodiment would allow the MTM to engage in secure web-transactions that do not necessarily require a PC (e.g. music/movie downloads, stock market access, etc).

IV.B. Achieving Trusted Boot from the MTM

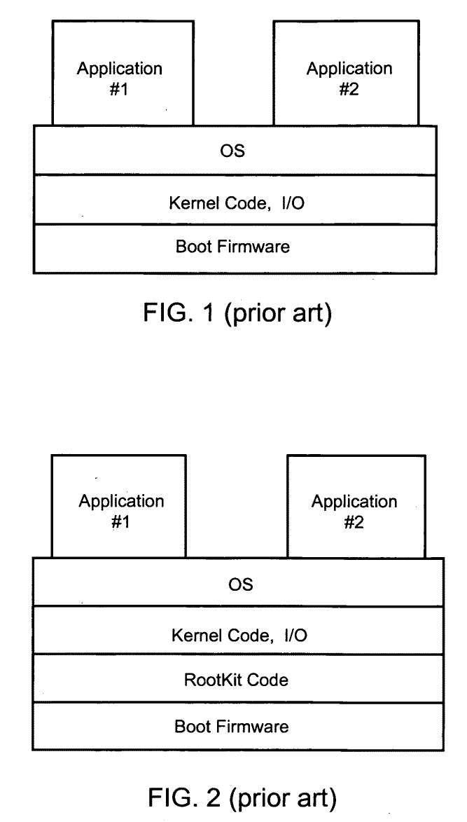

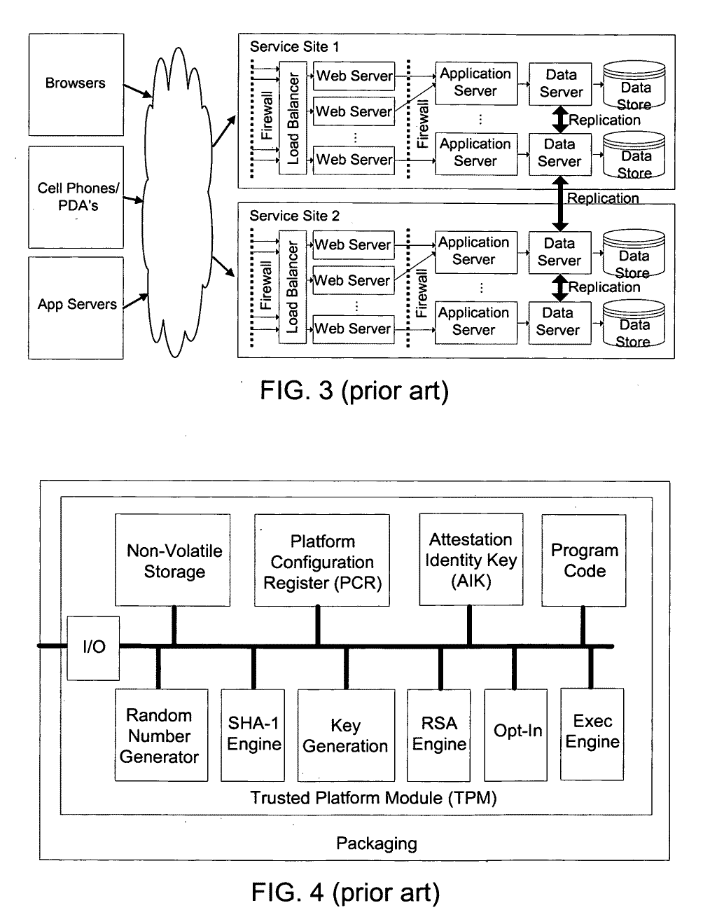

A significant percentage of mobile devices existing today, particularly portable computers, can have their BIOS configured (by an Enterprise IT department for example) to “BOOT FROM USB” in the BIOS Boot Order menu where the USB driver is BIOS ROM resident. This allows the system to boot from the MTM and a Trusted Boot process can be executed from the MTM using the previously described Transitive Trust model to install a TVMM onto the HMD as shown in the diagram of FIG. 10. Note that, unlike FIG. 1, the Boot Firmware is not resident on the HMD, but rather on the MTM. Most systems also offer a simple BIOS SETUP password that is independent of administrative password and is not programmatically accessible, offering additional security.

One challenge for the Trusted Boot from the MTM is to ensure that the HMD actually booted from the MTM—and that the HMD is not rootkitted and the boot spoofed. There are also new attacks that the hosted MTM implementation is subject to, including interception of the USB bus (a “man in the middle attack”), malicious software running on the host that mimics a host HMD that is booting from the MTM, thus “fooling” the MTM into believing a secure boot process had occurred, and malicious software that exists on the host “in the background” or “in hibernation,” avoiding detection while otherwise seeming to allow a secure boot to occur. Such malicious software might, for example, snoop on user keyboard or display I/O.

However, this implementation of MTM has several powerful resources at its disposal to mitigate such attacks. One resource is the secure time tick counter in the TPM on the MTM. This time tick counter holds the number of ticks in the current session. It can have programmable accuracy as fine as lus. Virus infections (including rootkits) have been shown to be vulnerable to discovery through execution time measurements, so the MTM can also execute random code challenges on the host MIEP and measure the execution times.

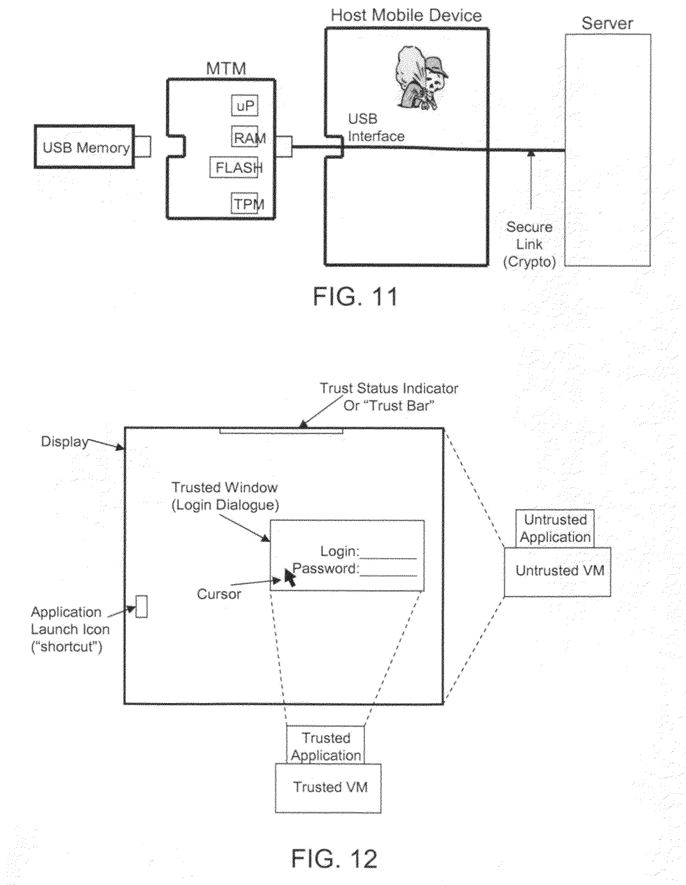

The MTM can also access a secure Server, and “cryptographically tunnel” through the potentially malicious host. By contacting a host and mutually authenticating based on a shared secret known only to the MTM and the Server, the MTM can leverage mutual resources with the server to verify the integrity of the host. This situation is shown in FIG. 11.

Once the MTM has determined that a secure boot has taken place onto the HMD, all further communications over the USB bus are encrypted, eliminating simple snooping attacks on the USB bus.

### IV.C. MTM Based Software Environment

In one embodiment, the operating state of a “warm” HMD is both preserved and usable after the Trusted Boot process from the MTM. In other words, the MTM is inserted into a running HMD and the VMM is dynamically installed “under” the existing OS and environment running on the HMD. In this scenario, the previously running OS and software environment on the HMD would, after the Trusted Boot from the MTM, be running in a VM hosted by the VMM. This approach has the advantage of leveraging the OS and the applications already resident on the HMD.

An alternate embodiment, which also preserves the state of the “warm” HMD is to HIBERNATE the HMD, and just before the HIBERNATE sequence finishes, initiate the Trusted Boot process from the MTM into the TVMM environment. Once the MTM is removed, or the user desires to revert to the previously running OS and environment, the HMD can be resumed from the HIBERNATED state.

When the TVMM is installed on the HMD as a result of the secure boot, the OS stored in the MTM (preferably LINUX) is loaded and runs on the HMD in one of the VMs hosted by the TVMM.

### IV.D. User Authentication in the MTM/HMD Combination

Achieving a secure boot from the MTM to the HMD preferably is a prerequisite for achieving secure user authentication, because the I/O paths through which the user authenticates are supported by the HMD and so preferably are “Trusted Paths.” It may be possible to add a fingerprint sensor integral to the MTM, and/or a microphone for speech recognition/authentication, which would make these additional authentication factors more secure.

### IV.E. MTM Status Indicators and Control Buttons

One of the most reliable techniques for detecting a rootkit on a PC is to force a hard reboot (by removing power) and booting from a known good external media (after insuring the correct BIOS boot order), such as CD, to then scan the system.

To provide increased assurance of user control of the MTM/HMD system, there preferably is at least one control button on the MTM to initiate a System Reboot (Trusted Boot) of the MTM/HMD pair, and/or to initiate a System Verification of the HMD of a Trusted Boot has already occurred. In one implementation, there are three lighted status indicators, or one lighted status indicator capable of three different colors. Green might indicate successful Trusted Boot or verified and trusted system status, Orange might indicate Trusted Boot or verification underway, Red might indicate that Trusted Boot or system verification has failed.

### IV.F. MTM as HMD Malware Scanning Locus

As a secure, portable, standalone compute capable entity, the MTM is a natural place from which to execute anti-malware software for an HMD, particularly upon initial boot and before any suspect HMD resident code is loaded and run.

Because of its ability to establish a cryptographic link to a secure Server and perform a mutual attestation protocol, malware signature databases and other information can be downloaded directly to the MTM from a Server, potentially through a hostile HMD. With these capabilities, the MTM can act as a disinfecting agent for HMDs.

As will be discussed further below, it is desirable, in order to minimize energy expenditure and compute burden on the MTM/HMD combination, that malware scanning tasks be place shifted/virtualized to the Server where possible.

### V. The Server in Support of the MIEP Model

In one aspect of the system model, the MIEP/server role is extended beyond that of a classic thin client client/server model in that the server and its capabilities can be viewed as an extension of, and subordinate to, the MIEP.

One of the important roles of the Agent Server (“Server”) is to optimize the functionality of the MIEP, particularly in the areas of security, energy efficiency, and/or mitigation of the functional limitations imposed by the OCC (Occasionally Connected Computing) model and physical and energy limitations of the MIEP. We call this MIEP functional enhancement “trusted functional virtualization”. This differs from typical web servers that provide web services on a demand basis to any client with minimal formal trust or security guarantees.

### V.A. Ideal Server Supports Protected Capabilities, Roots of Trust, and a Trusted Boot Process.

To fully realize the advantages of Server supported functional virtualization, the Server preferably is capable of securely and reliably attesting its state to the MIEP—and to do this it supports the infrastructure necessary for remote attestation, including Protected Capabilities (such as those found in the TPM), Hardware Roots of Trust along the TCG model, and a Trusted Boot Process. The Server trust and security architecture in effect mirrors the trust capabilities of the MIEP except that the superior resources of the Server allow it to create many more VMs to support numerous MIEPs. Also, the Server's observability across MIEPs provides an MIEP with additional capability for network-wide authentication and validation.

In the situation where the Server does not possess the security capabilities outlined above by the TCG, then the trust level can gracefully degrade to an “implied trust” model in the Server, although the virtualization functionality can be equivalent. This is most appropriate for enterprise situations where the Server supports a specialized provisioned client (MIEP) base, sits behind the corporate firewall, and is carefully managed and provisioned (so that trust can be implied).

### V.B. VMs on the Server Support VMs on the MIEP

In one embodiment, applications running in MIEP VMs can “spawn” VMs on the Server to create trusted hosting environments in which MIEP Agents can run. This spawning process preferably includes mutual authentication and attestation.

### V.C. Spawned Server VMs Conform to an API Supporting MIEP Agents

The Server side VMs preferably conform to an API to support Agent execution and communication with MIEP VM hosted applications. This API allows the use of a variety of Server types and implementations. The types of configurations that can be supported include the following shown below in Table 1:

TABLE 1
Server VM Support Options and Security Level

| Client | | Actual Security | |
|---|---|---|---|
| Type | Server VM Support | Level | Trust Level |
| MIEP | No VM Support | Weak | Implied Trust Possible |
| MIEP | OS Hosted VMs | Better | Implied Trust Possible |
| MIEP | Direct on Hardware | Better Still | Implied Trust Possible |
| | VMM | | |
| MIEP | TVMM | Strongest | “Formal” Trust & |
| | | | Attestation |

As can be seen in the table, overall MIEP/Server system security level increases going down the table. When the other, weaker, levels of security are utilized, the user preferably would be presented with the choice of whether to authorize Agent execution on the Server at that security level via some form of trust User Interface.

### V.D. Server VM Attestation to an MIEP VM

In one approach, VMs can attest to their state when challenged by an application running in an MIEP VM that has spawned a corresponding Server VM. This provides the mechanism for creating the trusted environment necessary for applications hosted in MIEP VMs to run Agents on the server to act on a proxy basis for the MIEP, and to provide dynamic validation of the trusted environment.

### V.E. The MIEP May Specify Capabilities of Spawned VMs on the Server

In order to customize the security environment of the Server VM, applications running on the MIEP VM preferably can control the Agent host environment by specifying capabilities of spawned Server VMs, including allowed I/O modalities. This specification of the Agent host environment can take the form of MIEP generated policies. As an example, the application running in the MIEP VM may specify that only the TCP/IP port to/from the server VM be enabled.

Note that this is the inverse of digital rights management situations where a content provider desires to specify policies on the MIEP VM, such as “locking down” the MIEP VM to which it is releasing content. Note that this is also the inverse of situations where corporate policy is to be enforced on the MIEP VM (such as allowed I/O modalities) to create a sufficiently secure environment to enable functionality such as Single Sign On (SSO), or the secure hosting of virtual desktop, terminal client, or push data environments.

### V.F. Server VMs Can Be Shared

For implementation efficiency reasons, it is usually desirable that applications running in different MIEP VMs be able to share the same Server VM, provided that sufficient security criteria are met by each participating MIEP VM.

### V.G. A TVMM Implementation Inherently has Minimal Trusted Path Issues

Existing proposals to deal with trusted path issues involve adding hardware/software complexity to the MIEP. Examples include encrypted keyboard I/O, encrypted screen I/O, adding TPM type functionality to motherboard based Flash Memory, and adding TPM type functibnality to USB memory sticks. We term this a “distributed TPM” approach where, because the central mobile device implementation (software environment/OS) itself is not trustworthy, the mechanisms necessary to establish trust in these peripheral system resources have been pushed out to the peripheral system resources themselves.

### V.H. Trust Level Indication UI—Visual Attestation

An important UI requirement for any MIEP that simultaneously supports trusted and untrusted VMs and application software is to indicate to the user the trust level of the application and/or VM he is interacting with. We call the overall capability of securely displaying to the user the trust state of the MIEP “visual attestation”.

An important functional requirement to support visual attestation is the ability to place portions, and in some cases, all of the framebuffer under exclusive control of the VMM, or the console/DOMO VM under direct control of the VMM that is responsible for physical hardware I/O. This dedicated portion of the framebuffer under VMM control then provides trust status feedback according to configurable policies, and can be used for other user authentication purposes. There is then at all times a “trusted path” to said dedicated framebuffer portion of the display from the VMM.

There are two fundamental UI operating modes to consider:
1. “Windowed” mode, where both untrusted and trusted software share the same displayed framebuffer, along with the trust indication status area owned by the VMM; and
2. “Full screen” mode, where the entire framebuffer, except for perhaps trust indication status, is exclusively written by either by trusted or untrusted software, such as a VM or application, along with the trust indication status area owned by the VMM.

In the Windowed mode case, the challenge is how to provide secure display based I/O to trusted software within a framebuffer shared by untrusted software, and to do so with minimal impact on either the performance or the pre-existing windowing models and behavior. It is desirable to implement this simultaneous support of trusted and untrusted “windows” as it provides a more seamless user experience.

Refer to FIG. 12 for an illustration of a secure log-on example. Here, with the exception of the trust bar at the top of the screen, the display (rendered from the framebuffer) is currently owned by an untrusted VM (as illustrated by the dashed lines to the Untrusted VM). In this environment, the trust bar at the top of the screen indicates an untrusted state status—perhaps by displaying a red color. There are icons on the screen, representing shortcuts, that initiate execution of trusted applications running in a separate trusted VM (shown at the bottom of the Figure). If the application launch shortcut is clicked on, control will preferably be passed from the untrusted VM to the VMM, and then to the trusted application running (in this case a log-on dialogue) hosted by the trusted VM, where the trusted application paints a window into the framebuffer (as shown by the dashed lines), such as a login dialogue box, for display on the screen. The trusted application provides to the VMM the window perimeter values (where in the framebuffer the box is placed) of the dialogue box to the VMM, and from that point on that portion of the display/framebuffer is locked for exclusive use by the VMM for that trusted application. This means that untrusted applications cannot write or read (“screen scrape”) the framebuffer contents and use character recognition or other techniques to recover confidential information such as User IDs, and that portion of the display is always maintained in the foreground, so that it cannot be overwritten by a malicious program in an effort to phish.

A prerequisite for correct operation is that there be a trusted path to the keyboard and mouse. That is, once the cursor is placed within the trusted window, that window has I/O focus and that focus cannot be changed by another application until the user moves the cursor out of the trusted window, and only user generated movements of the mouse can move the cursor. This will prevent untrusted software from “stealing” keystrokes by momentarily switching focus to another window without the user intent and action of moving the cursor out of the trusted window. Only while the mouse is within the perimeter of the trusted window is the trust indicator at the top of the screen set to the trusted state (perhaps displaying a green color).

Note also, that once a trusted window is to be released by a trusted application, where that area of the display is to be “returned” to the framebuffer for use by potentially untrusted applications, that section of the framebuffer should be first written with a random pattern. One skilled in the art can readily understand variations to the above approach, such as wishing to display the window representing an untrusted application within a framebuffer generally controlled by a trusted application—but all rely on the existence of trusted paths to the framebuffer, the keyboard, and the mouse—and the enforcement of transparency and predictability of I/O focus to the user.

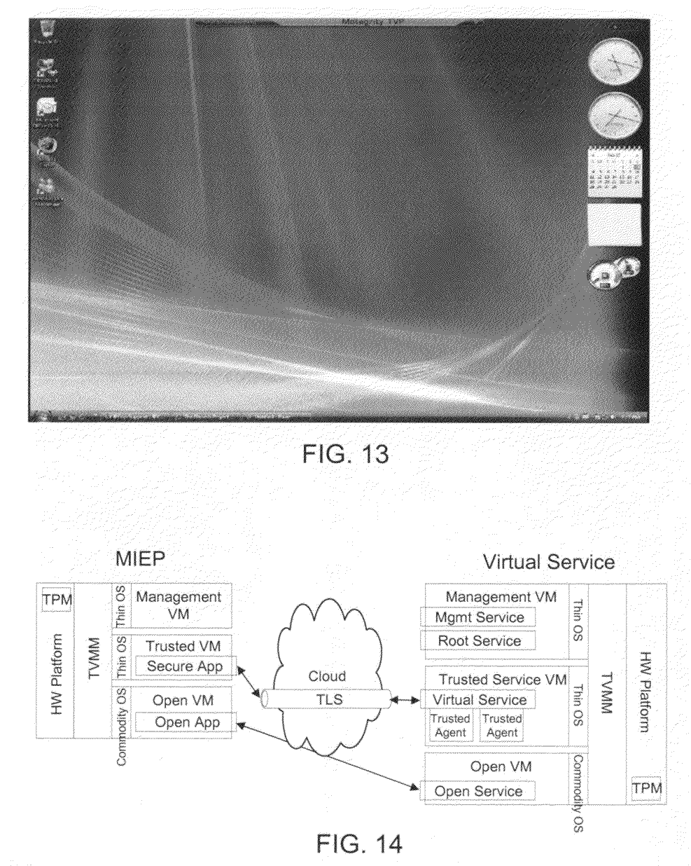

FIG. 13 shows an example of the “full screen” mode, where a “trust bar” at the top of the screen indicates to the user that the current window (which is a full screen display) the user is interacting with can be trusted. The trust level of the indicator is a matter of policy, but we take it to mean that the execution environment supporting that particular window is attestable. In this example, a virtual machine provisioned for access to a particular set of corporate resources, in this case VM Engineering, is shown.

The “trust bar” at the top of the display is controlled exclusively by the VMM or console/DOM0 VM, and, in this example, overlays the screen image controlled by the host VM and/or the application(s) hosted by that VM. The trust bar overlays the underlying window in a semi-transparent manner, indicating that this VM can be trusted. This is one visual method of indicating trust. Another might be to frame the entire display with a thin border of a certain color, such as a shade of green If the current display/framebuffer owner cannot be trusted, we use the convention of indicating untrusted status by turning the trust bar a transparent red with a black border around it. One skilled in the art can readily understand there are many possible visual mechanisms of displaying trust level—but none are reliable unless that part of the display/framebuffer displaying the trust level is exclusively controlled by a fully trusted resource, such as the VMM, guaranteeing a trusted path to that physical I/O resource.

V.H.1 Extending Trust Level Indication to Server Based Agents

Note that the trust bar concept, coupled with the ability of the MIEP and the Server to mutually attest to each other, can be extended to also enable the display to the user of the trust level of the software running on the Server. An example would be a VM that that user has spawned on the Server to host an Agent or a service on the MIEPs behalf. If the VM and hosted Agent can successfully attest to the correctness of their state to the MIEP, that information can be displayed in the trust bar in a manner similar to that described above.

### V.I. Global State Cache

With the continuing rapid decline in the price per bit of non-volatile memory (particularly NAND FLASH), a memory technology that uses very little quiescent power, it is attractive to leverage this resource to maximize functionality under the OCC model while minimizing MIEP energy requirements.

One approach is to create a substantial cache on the MIEP, called the Global State Cache (GSC), that caches user internet state, including data and programs. The GSC is managed on a contextually appropriate basis. Relevant contextual variables include time, location, available internet bandwidth, energy availability, and task. Although it is tempting to use simple “fetch ahead” type strategies to manage the GSC, such strategies have been shown to be energy inefficient.

The GSC will help maintain operational coherence in support of the OCC model. By operational coherence we mean that should connection be lost, there is sufficient state in the MIEP to continue meaningful computation/workfor the typically expected connectivity loss duration.

One strategy for maintaining cache contents that offers significant improvements is to use a running history time series ofpast contextual data, such as location and task, to predict future needs and thereby optimize the GSC maintenance policies.

### VI. Software Architecture of the Agent Services

### VI.A. Virtual Services

Leveraging Trusted Computing technologies as outlined in the previous sections allows for the development of mobile applications and services using a distributed virtualization model that spans the network between them: Virtual Applications that provide some service to mobile users, combining the rich context and availability of mobile platforms with the reliability and ubiquity of web services in a seamless manner. This is facilitated by a system, enabled by a TVMM with a core root of trust that preferably:
1. Provides trusted functionality through the use of virtualization on both the MIEP and the TSEP (Trusted Service EndPoint),
2. May be driven and controlled by the user, where the trusted application on the MIEP causes the instantiation of a Virtual Service on the TSEP,
3. May be driven and controlled by the service provider, where the Virtual Service initiates the instantiation of a trusted application on the MIEP to provide some trusted service, and
4. Supports both unidirectional and bidirectional (mutual) attestation as required by either party (MIEP or TSEP).

In one approach, a platform or environment supports applications that take advantage of connectivity and mobility through the use of Virtual Services. In this platform, trusted application components on the MIEP are associated with trusted service components running on the TSEP. These components, which are running in trusted VMs at both Endpoints, attest to and communicate with each other through an encrypted link that is dedicated to their association. Because of this link, these mobile and service-based application components comprise a single Virtual Application that spans the network between them in a transparent way.

Note that the a TSEP is generally resident on a server, but not necessarily so. The TSEP could just as easily be resident on another VM on the MIEP.

FIG. 14 shows an example architecture for these Virtual Applications. Trusted applications running on the MIEP are associated with Virtual Services and vice-versa. Specifically, the architecture would leverage a HROT, such as a TPM to provide a trusted boot sequence which encapsulates a TVMM that hosts both trusted and open (untrusted) VM's. These VM's host one or more agents and are spawned in response to a request by a MIEP.

Note the following:
1. Components of a Virtual Application mutually attest, and leverage that attestation to authenticate to each other.
2. These components reside in trusted VMs on the MIEP and on the TSEP. The trusted VM's on the TSEP host a service software stack to form what we call Virtual Services.
3. A review of the currently used service software architecture makes it apparent that Virtual Services themselves may actually be comprised of a plurality of Virtual Services, each dedicated to a specific tier. FIG. 15 depicts this specific deployment model.
4. Multiple trusted Agents can be hosted in a single Virtual Service VM.
5. Attestation between components is done in a manner that is independent from the user session. This is an important distinction for the Virtual service architecture, which may spawn several instances of the same Virtual Service VM; one for each of several user sessions.
6. When a remote VM is spawned by an application running in a local MIEP VM, the VM's (and potentially the Agent(s) and/or application(s) running in those VMs) mutually attest independent of user authentication. Since, for example, a Trusted Application on the MIEP trusts and is trusted by the Virtual Services components, there is no need for the user to be authenticated by the Virtual Services components. User authentication is generally policy or application driven and generally occurs between the MIEP and the user. User authentication could be required, for example, only when the user wishes to spawn a remote VM to host a trusted Agent, or when the user wishes to access protected content which requires access to protected resources contained in the TPM. Note though that a user authentication request by any application is not precluded. Such user authentication is typically done using means such as a shared secret (password) or a biometric measurement or a combination of multiple authentication factors.

### VI.B. Complete Virtualization of Services

The characteristics of the Virtual Service architecture changes somewhat when one considers the implementation of multiple tiers that are common in Service Software Architectures. FIG. 15 depicts the Virtual Service architecture in a multi-tier deployment. For the sake of brevity, we have foregone the depiction of scalability and redundancy. That is not to imply that these concepts could not or would not be applied to the service architecture illustrated above. In fact, the service site shown in FIG. 15 is intended to support complete redundancy of service.

Note the following:
1. The Load Balancer need not be trusted in order to produce a trusted virtual service. Requests between the MIEP and the Web Server tier would naturally be encrypted, protecting it from exposure to exploits on the load balancing platform.
2. Both the Web and Application Server support trusted VM's that host Agents. The function of these Virtual Services is to provide an attestable platform from which to run Trusted Agents on behalf of applications running in trusted VM's on the MIEP.
3. Virtual Services host Agents on the Web server and the Application server that are correlated to each other. This correlation may be on a 1-to-1 or 1-to-many basis depending upon the Agent functionality.
4. The Data Service (based upon a platform such as Oracle or Microsoft SQLServer) need not run in a trusted VM. The data correlating to an individual MIEP user would be encrypted and tunneled through the server. This could and would include indexing information used for queries of sensitive information.

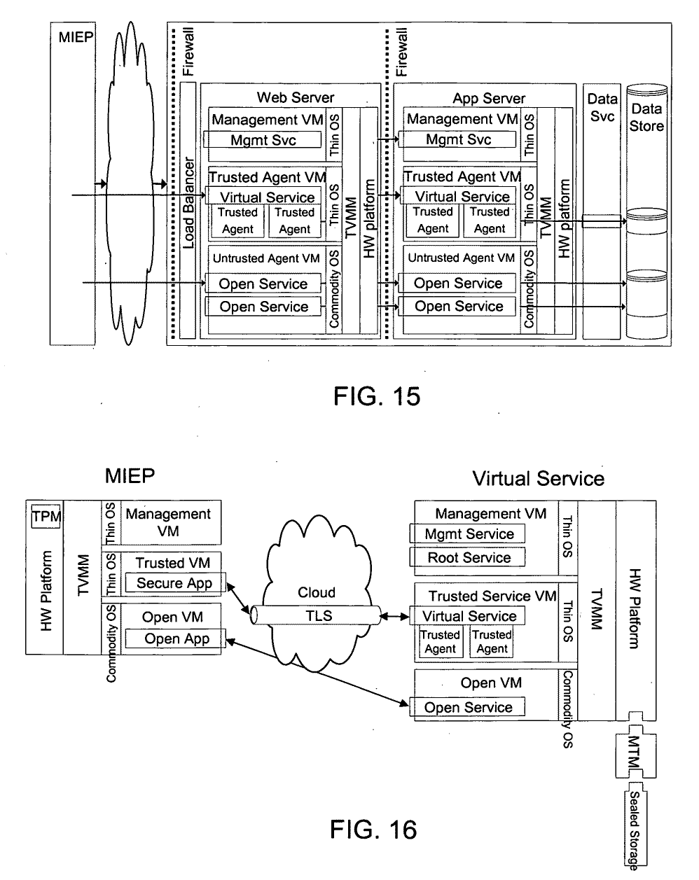

In addition:
Virtualization across tiers—As discussed above, Web and Application services preferably each host trusted Agents that are somehow correlated to each other, supporting a single user session running on a MIEP. User sessions would generally be managed through the use of a Single Sign-On (SSO) solution and Virtual Services attest to each other and to the MIEP across these tiers without compromising trust.
Repository Encryption—The encryption of individual rows or entries in a standard Data Store introduces some interesting problems for data query/recovery. Most notably, when queries of sensitive information are necessary, the keys for that search can also be sensitive. It can be necessary, therefore, to engage an indexing scheme on the Data Store that utilized encrypted search keys.
Hardware support—The equipment that is in use today in Web Service deployments comes in a wide variety, from low cost Intel hardware running Linux to expensive Sun and IBM machines running Solaris and AIX, respectively. Support for and adoption of a trusted boot sequence based upon a HROT such as a TPM in all of these environments and platforms will take time, and indeed, may never come about for some of them. The use of the Mobile Trust Module (MTM), described in previous sections, will provide access to HROT based functionality for some of these platforms, but many legacy service systems will continue to rely on traditional security measures. FIG. 16 shows the use of the MTM for this purpose in one possible implementation of a virtual server environment.

### VI.C. OS Hosted Virtualization of Services

Although not an ideal embodiment, a reasonable alternative embodiment could utilize OS hosted VMs, perhaps using a Type-2 hypervisor, to provide some reasonable level of security and trust for the Agents hosted on the service architecture. While the VM is hosted on an untrusted platform, specific measures can be taken to ensure a level of trust.

Storage Encryption—Storage utilized at the data store can be encrypted utilizing some standard form of repository encryption that is keyed off of key material originating from the MIEP.

Memory—The OS-hosted VM can be augmented to provide encryption for at least parts of the memory space assigned to the VM designated as critical. In fact, given the availability of processing power and the scaling aspect of the service architecture, the entire VM memory space can be encrypted.

Attestation—It is not possible to attest for the host OS or the platform in this architecture, but the static aspects of the VM can support attestation. Encryption of the VM storage and memory space makes the spoofing of VM attestation information difficult and time-consuming.

Path Limiting—Generally the data utilized or stored for the implementation of the Agent originates with the MIEP, especially for Agents that are spawned by the user via interaction with the MIEP. In this general case, the access to devices and resources on the server can be limited to the processor, memory, storage and network ports. Network access can utilize standard encryption methods for securing information passed between the MIEP and the Agent as well as for information passed between the Agent and the Internet.

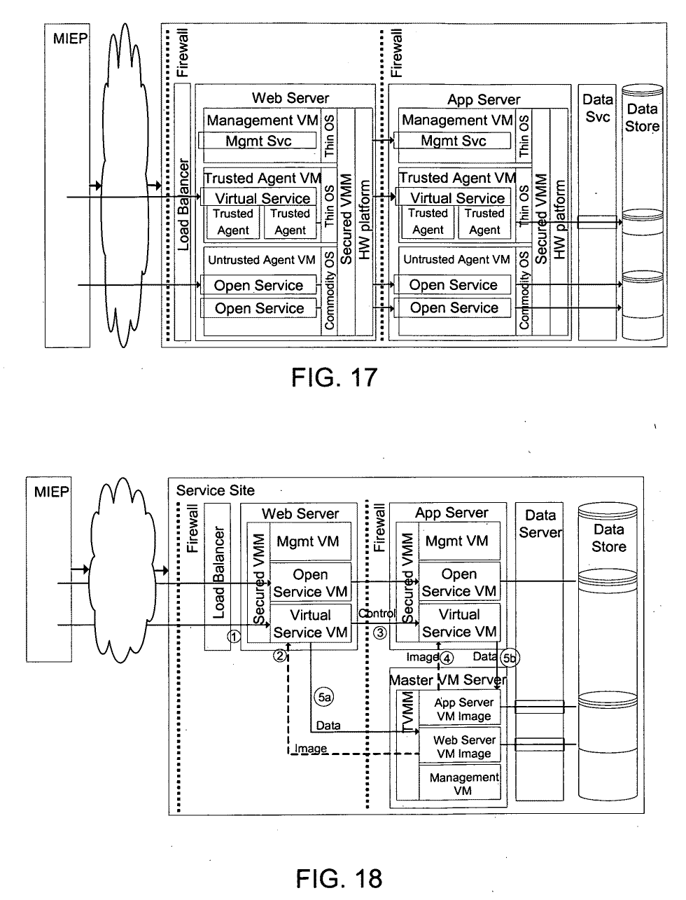

In FIG. 17 we show that an OS hosted, secured VMM can provide some level of trust to the Agent Service architecture. We are calling this VMM the Secured VMM because it does provide some level of security, but cannot be labeled Trusted. While the approaches that can be employed for securing this VM are effective, an exposed server can still be hacked, given enough time. Attestation has degraded value, because it can be spoofed by a modified Agent. More importantly, though, is the fact that once a Trusted Agent is compromised, the user keys that secure the users data in the Data Store are compromised as well. This means that all of the user data in the store are exposed if any part of it is.

### VI.D. TVMM Based Agent Master

The secured OS hosted virtualization system described above can be augmented through the introduction of some components that support the complete TVMM model. One possible example is the use of a TVMM Based Agent Master, which supports the trusted boot process and that can fully attest to the MIEP. As depicted in FIG. 18, this master would
1. Store any or all keys associated with the user or MIEP and would be utilized by the various Web Service components for all authentications without exposing these keys.
2. Provide the attested static VM images that are used as a template for each Agent. This is basically whatever OS/application that comprises the Agent functionality without any user state associated with it.
3. Expose a gateway interface to the storage tier so that access to any sensitive persisted agent data is done only through this component by an OS hosted VM that is spawned and attests to an image on the Master.

This approach does not per se prevent the hacking of OS hosted VM's on the Web or Application servers, but it does make that hacking much more difficult, due to the ephemeral nature of these VM's. They are spawned to service one specific task or request and are removed as soon as they are done. Hacked Agents cannot survive the spawning process because their code is never committed to storage on the running server. Furthermore, if one of the VM instances is exposed, only the user data it is trusted with is at risk. The user keys do not leave the VM Master.

In short, using this approach all keys are secured by a fully attestable VM Master, the user data store is secured by the VM Master, and the VM Master will only honor fresh requests made by a VM that was spawned by it and is still attestable. Furthermore, the OS hosted VM can only access the limited subset of secure data registered to it.

In FIG. 18, a service request from the MIEP results in the following steps:
1. The request is received by a service running on the Web Server.
2. The response of the Web Server is to load a fresh copy of the specified Web Server Image from the Master VM Server into a Secured Agent VM.
3. The Web Server image contacts the Application Server as part of its expected functionality.
4. The Application Server platform loads a fresh Application Server Image from the Master VM Server into a new Secured Agent VM.
5. All access to secured data from either the Web or Application tiers is done through the Master VM Server using keys that are only accessible there and never on the untrusted servers hosting the Web or Application tiers.

### VII. Description of Agents and Agent Operation

We describe some possible Agents that are facilitated by aspects of the invention. These examples below represent just a few of many that are possible.

### VII.A. Web Browsing Agent

A web browsing agent acts as a proxy for the user for the purposes of improving privacy and anonymity and decreasing the code size and energy “footprint” of the browsing functionality on the MIEP. The web browsing Agent virtualizes the user, placeshifting him to the server from the perspective of the target web service.

The following benefits can accrue:
1. The actual user IP address can be hidden, vastly improving anonymity and privacy, although the system is still vulnerable to correlation attacks where the adversary has access to both the input and output IP streams to the server hosting the Agent.
2. Anti-malware software can run as part of the Agent environment, scanning data traffic as it is passed to the MIEP, eliminating the related energy expenditure on the MIEP.
3. A full browser can be instantiated at the server, while a lightweight user interface can be implemented at the MIEP that simply renders compressed browser images.
4. Security settings at the Agent can be relaxed (such as enabling cookies) over what the user might normally allow; improving website accessibility (many websites fail to function properly unless cookies are fully enabled). Scripts and other plug-ins that would not normally be enabled could be allowed at the Agent because the MIEP and the user's non-browser resident local data could not be compromised.

### VII.B. Web Content Filtering Agent

Much of the content of typical web pages consists of advertisements, and these advertisements are often image content in the form of .gif or .jpg files that dominate the web page in terms of total data payload. The purpose of the filtering Agent is to remove and/or filter this extraneous content to minimize downstream bandwidth requirements (and related transmission energy expenditure) to the MIEP and required rendering energy. This Agent would be preferentially a component of the Web Browsing Agent, but could be a standalone Agent if a Web Browsing Agent is not used. This type of Agent is also beneficial to the wireless network carrier as the wireless network capacity (the number of users that can be supported) can be increased if the average data bandwidth to each user can be decreased by filtering and compression.

### VII.C. Malware Scanning Agent

Security requires energy expenditure, and one aspect of the invention moves as much of the anti-malware related energy expenditure, software complexity, and code size footprint to the Server as possible. This implies a paradigm shift in the current monolithic application model of anti-malware software for the PC in that in the mobile world the functionality is preferably partitioned between the MIEP and the trusted server. Provisioning can also be simplified as much of the actual scanning process is centralized, minimizing the need to “push” malware signature databases to leaf nodes.

IP traffic that arrives in plaintext can be easily scanned by the Agent. Examples of such traffic might be email where the Agent is scanning for SPAM, etc.

An advantage of the trusted Agent approach is that the Agent may have access to keys used by the MIEP for decryption of IP traffic, can therefore decrypt that traffic, and thereby scan a larger percentage of the traffic bound for the MIEP.

From the enterprise perspective, when combined with policies to “lock down” the corresponding VM on the MIEP to maximize security and to uniformly provision, along with malware scanning using a Server based Agent, these practices constitute an important component of “extending the corporate firewall” around the MIEP.

Another potential use for a Malware Agent is to scan data that is “passed thru” the MIEP to the Server. If the MIEP is browsing the web directly and wishes to download potentially harmful content, it may choose to upload the data to the scanning Agent on the Server to be scanned, or perhaps redirect the data stream directly to the web based scanning Agent, rather than perform the scan locally, depending on energy and cost tradeoffs of local vs. remote scanning.

### VII.D. Behavioral Monitoring Agent

Polymorphic/metamorphic viruses and zero-day attacks can escape static signature detection, and for these threats behavioral monitoring during runtime is often employed to flag suspicious behavior. Typical techniques include instrumenting kernel level routines and hooking the system API calls and passing data in real time to analysis software that utilizes heuristic rule systems or employs learning/neural net techniques. The drawback is that these systems run continuously, and therefore can consume considerable energy.

An alternative system is to instrument the MIEP VM, and then pass compressed “signatures” of real-time execution behavior to the Trusted Server based Behavioral Monitoring Agent for analysis. If the analysis energy expenditure is larger than the data transmission energy expenditure, then the approach is advantageous, although the response latency is likely increased. So for situations where rapid response is critical, it may be necessary to run that specific behavioral monitoring on the MIEP.

### VII.E. P2P Agent

Most P2P networks, including examples such as Napster, BitTorrent, KaZaA, and eDonkey, require that the network client (peer) support an upstream data channel that is independent of actual user generated upstream data, in order to maintain the network. However, this upstream data support requirement usually is not desirable for the following reasons:
1. Energy expenditure: The MIEP cannot afford the energy expenditure for traffic which is not directly associated with user demand or user productivity.
2. Data transmission cost: Depending on the location and/or carrier policy, data transmission might be costly. In Europe for example, “all you can eat” wireless data access is not yet the norm.
3. Asymmetric I/O: MIEPs may frequently operate with channels to the web that are highly asymmetric (where the downstream bandwidth is much higher than the upstream bandwidth), a situation not favorable for P2P support.

Like the Web Browsing agent, the P2P Agent can service the P2P network on behalf of the MIEP without exposing the MIEP identity.

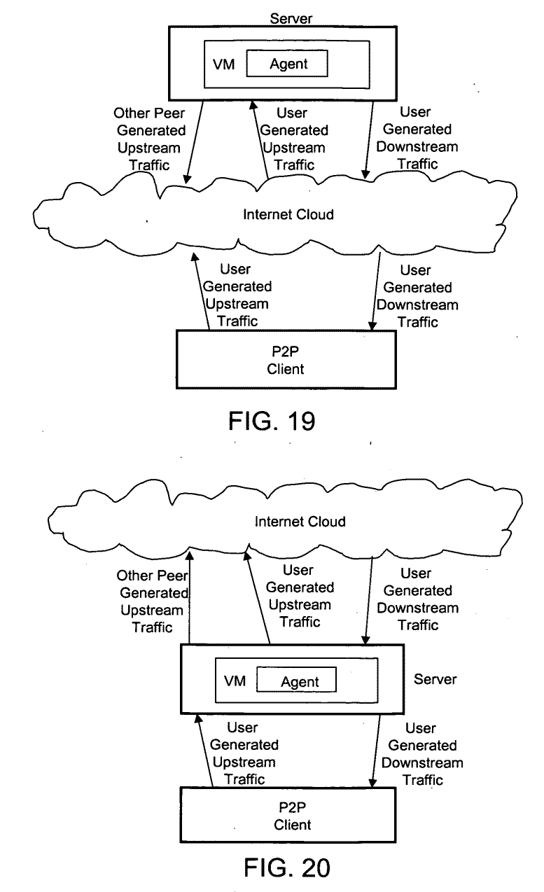

FIG. 19 diagrams an example P2P Agent addressing these issues, from a physical point of view. FIG. 20 diagrams the P2P Agent from a logical point of view.

### VII.F. Data Compression and Transcoding Agent

A classic “thin client” implementation is one where the client simply presents a viewport into an application running on a server. Providers of such “Virtual PC” thin clients include NEC, Sun, CLI and others running software from providers such as Citrix. This model is facilitated by a dedicated reliable high bandwidth link between the client and the server. Data passing between the thin client and the server are often compressed to minimize enterprise network bandwidth requirements.

However the variable quality of the communications link between the MIEP and the Server, resulting in an Occasionally Connected Computing (OCC) model, makes the classic Thin Client model more difficult, so the MIEP should be capable of standalone operation. One goal of a data compression and transcoding Agent then is to support a mobile OCC model by reducing energy expenditure at the MIEP and reducing data transfer latency.

One of the prevailing current commercial examples of a data compression and transcoding system is the Opera Mini Browser. Opera Mini fetches all content through an Opera proxy server that runs the layout engine of the browser. The engine on the proxy server reformats web pages into a size that is suitable for small screens. The content is compressed and delivered to the phone in a markup language called Opera Binary Markup Language (OBML). Content is typically compressed by 70-90%. However, there are some difficulties with the centralized proxy server approach to this functionality:
1) The centralized server is a potential performance bottleneck, both from the perspective of I/O bandwidth to/from the server, and of the computational resources that can be expended on each client.
2) Compression and transcoding is typically not personalized to the individual user's preferences or mobile device contextual situation.
3) Lack of privacy for the user (the user identity is transparent to the server).
4) The central server has to be involved in Digital Rights Management (DRM) transactions whereby protected content is released to the browser for display.
5) Additional compression can be achieved if the server could decrypt and examine stream types that are encrypted to apply the optimal compression type.
6) A third party proxy server provider may not be motivated to strip out content for which they obtain revenue (such as advertising content) that the user would just as soon remove.
7) In order for standard browser encryption to work (SSL or TLS), the intermediary server needs to decrypt and encrypt on behalf of the thin client. If that server is untrusted, there is no way to perform secure transactions (online banking, trading, etc) in a verifiably secure way.

We address these issues with a trusted Agent based approach that is personalized for each MIEP, and that can be deployed on a decentralized basis.
1) The Agent can be deployed in a decentralized basis, eliminating single server performance bottlenecks. Greater computing resources can therefore be dedicated to each client, including more sophisticated compression schemes, stream type examination, as well as decryption and re-encryption of data.
2) The Agent can be personalized to user/session preferences.
3) An independent Agent improves the privacy and anonymity of the user, particularly if the Agent is hosted on a Trusted Server.
4) DRM transactions can proceed directly to the VM on the MIEP—bypassing the Server.
5) Encrypted streams can be decrypted and examined for additional compression and transcoding opportunities. Once decrypted, for example, image content can be appropriately decimated based on knowledge of the target screen size. Image content might be re-compressed with a more efficient, but lossier compression encoder, or transcoded in a more efficient encoding, whereas a stream such as compressed speech might be left alone.
6) Undesirable content, such as advertising content, can be stripped from the web page before being compressed/transcoded and transmitted downstream to the MIEP, with such filtering mediated by individual user preferences.
7) Verifiably trusted Agents can handle the proxy behavior for encrypted (SSL/TLS) transactions, performing the transcoding task on behalf of the MIEP in a secure manner.

### VII.G Communications Channel Virtualization Agent

This functionality was discussed previously in the Communications Channel Virtualization section. A trusted Agent running on the Server acts as the “sink” to aggregate the multiple communications links on the “Server side” of the Internet Cloud. Requests to web based services, for example, are then relayed back out over the Internet by the Agent to the service provider.

### VII.H. Data Storage Agent

The data storage Agent acts as a broker to store/retrieve data to/from the various storage locations (such as Amazon's Simple Storage Service—S3) via the web. The Agent makes intelligent decisions about where to store the MIEP data based on user weighted parameters such as cost, access latency, and storage location. The Agent handles encryption/decryption of data before it is forwarded to the appropriate storage location, thereby relieving the MIEP of that compute and energy burden.

### VII.I. Application ViewPort Agent

This agent mediates classic thin client functionality in that it interfaces a viewport on the MIEP to an application running on behalf of the MIEP on a VM on the Server. This agent acts as a virtual screen and UI I/O channel for the application, passing the screen image down to the MIEP for rendering on a viewport. With this capability, software can be run on the Agent that is not “installed” on the MIEP or where the energy cost is too high to run locally or where the local compute resources are inadequate. An example might be an engineer that wishes to run a large Matlab simulation.

### VII.J. MIEP Global State Cache Management Agent

One purpose of the Global State Cache (GSC) is to improve MIEP functionality under the OCC computing model while minimizing MIEP resource requirements. This Agent uses contextual clues, past behavior (including location and internet connection quality), current MIEP status and task set, along with user specified parameters, to prefetch into the cache that state (data, programs, etc) which will maximize MIEP functionality at present and near future. Since prefetching into the cache that state which is not necessary is wasteful of energy and communications bandwidth, a highly intelligent contextually aware GSC Management Agent can be advantageous.

### VII.K. Transaction Management Agents

These types of Agents broker MIEP transactions when the MIEP or the user is unavailable. An example might be bidding on an eBay item where the user does not want to bid until a few seconds before the auction ends, but is not confident in the communications availability or latency of the MIEP. Another example might be a situation where the user wants a transaction Agent to monitor airline prices to shop for the best deal to a destination within a certain set of parameters. It is important that the Agents be trusted and operate in a trusted environment so that the user can leave with the Agents those passwords or other authentication and purchase information necessary (such as credit card information) for these Agents to act as a full proxy on behalf of the user.

### VII.L. Web Identity Broker Agent

This Agent maintains the various identities (authentication data, etc) used to interact with a variety of web sites and services to create a virtual Single Sign On (SSO) function to the web. The Agent based approach has an advantage over a centralized approach in that the Agent can be owned and controlled by the user, allowing Agent code and security measures to be personalized to individual user requirements. Another advantage over centralized systems that propose leveraging SIM cards at the Endpoint for authentication purposes is that wireless carriers often do not expose SIM data outside their network, typically supplying only session based IP addresses to the web. In other words, the authentication is not end-to-end. Use of a HROT such as the TPM insures secure end-to-end authentication regardless of which network the MIEP is utilizing to communicate with the web.

### VIII. Aspects of System Operation

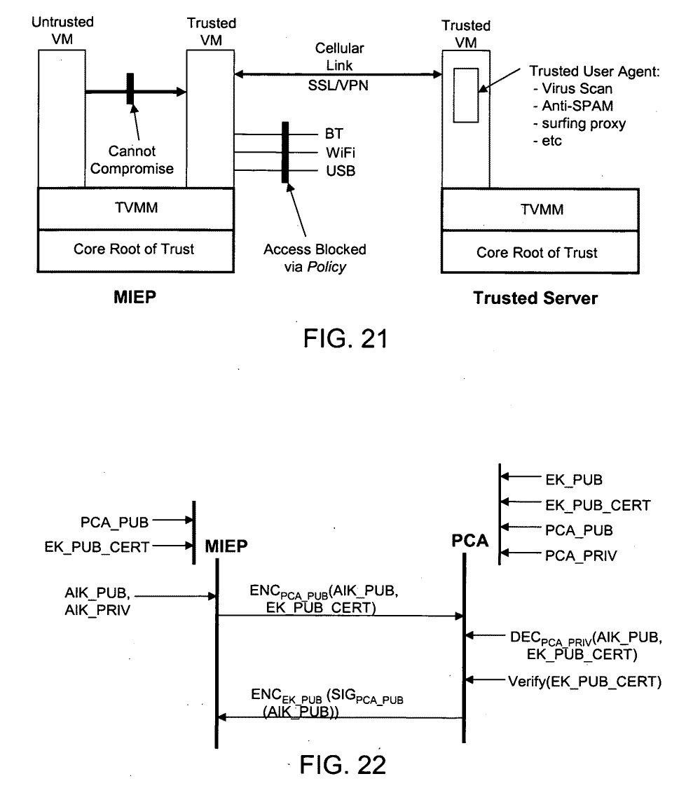

The relationship between the MIEP VM instance and the Server VM instance is shown schematically in FIG. 21. The diagram illustrates an example embodiment for situations where applications running in a trusted VM on the MIEP wish to run trusted Agents on the Trusted Server. The untrusted VM (on the left) on the MIEP cannot compromise the Trusted VM because of the use of the TVMM to isolate these VM instances. Furthermore, in this particular instance a security policy is established whereby only one of the many possible WAN connectivity links to the server is enabled from the Trusted VM (say Ethernet for example). All other I/O modalities such as BlueTooth (BT), WiFi, USB, etc. are disabled. On the Server side, the Trusted VM hosts trusted Agents executing on behalf of the MIEP application hosted in the MIEP trusted VM. Because these VMs can mutually attest to each other, and the link between them is secure (VPN for example), applications such as anti-malware, web surfing proxy, P2P proxy, etc can be run on the Trusted Server in a trustworthy manner on behalf of applications hosted by the trusted VM.

### VIII.A. Mutual Attestation

VIII.A.1 Authentication Prior to Attestation—Use of AIKs

As was highlighted in the example above, the ability for independent parties to mutually attest to each other's state is highly desirable. However, before attestation can take place the parties must authenticate each other's identity. This is done indirectly by digitally signing the PCR (Platform Configuration Register) values—residing in the TPM—to be delivered to the challenging entity using an asymmetric key pair.

Since Endorsement Keys (EK) are never made public, the TCG protocol calls for the use of a pseudonym, or alias, of the EK in the form of the Attestation Identity Key (AIK). The AIK is also an asymmetric key pair, and a TPM can create a virtually unlimited number of AIKs. AIKs are signature keys that are used to sign PCR values for delivery to a challenging third party.

However, for privacy reasons, it is preferable that the AIK not be linkable to the platform/TPM that created it, and so the TCG has designed a trusted service provider (or Trusted Third Party (TTP), the Privacy Certification Authority (PCA) to provide AIK Certificates.

VIII.A.2 Attestation Protocol Using AIK Certificates

We describe below a representative attestation protocol for a challenger wishing to run a secure application in a secure environment on the MIEP. A similar protocol occurs when a challenger (an application on the MIEP) wishes to run an application in a secure environment on the Server. This is not meant to be a definitive description. There are many possible variations.

Note that since the TPM is virtualized in our preferred embodiment, the protocol appears to the challenger as if it is dealing with a platform running a single OS and possessing a single TPM. This embodiment then supports our “compartmented attestation” model.

When a new TPM starts to function for the first time, a TPM Activation Protocol is run in which either the manufacturer, or a Trusted Third Party (TTP) Certification Authority (CA) generates an Endorsement Key pair (EK_PUB, EK_PRIV) consisting of the public (_PUB) and private (_PRIV) keys, which are installed into protected locations in the TPM, and also generates an Endorsement Certificate (EK_PUB_CERT), signed by the manufacturer or CA's public key, containing EK_PUB, the TPM version number, and manufacturer or CA identification information. The EK_PUB_CERT is stored on the platform, but not on the TPM.

The owner of the platform “takes ownership” of the TPM by inserting a shared secret into the TPM that is encrypted by EK_PUB.

The EK may not be used to create signatures; it may only be used to establish the TPM owner and to create AIKS, which act as pseudonyms for the EK. AIK key pair generation is completely controlled by the platform owner. AIKS in turn, may not be used to encrypt, but only for purposes of digital signature by the TPM on information such as PCR values.

AIK Certificate Generation: In order to avoid linking the AIK to the platform identity, and thereby protect the user's anonymity, a TTP CA is used—the so called Privacy CA (PCA) to provide a certificate for the AIK_PUB part of the AIK key pair.

An example of an AIK certificate generation protocol is diagrammed in FIG. 22. At the start of the protocol, the MIEP holds the PCA_PUB key, and the EK_PUB_CERT. The PCA holds the EK_PUB, the EK_PUB_CERT, and the PCA key pair.

After generating an AIK pair, the platform requests an AIK certificate (AIK_PUB_CERT) be generated by sending to the PCA, via secure channel or encrypted with PCA_PUB, a bundle consisting of the AIK_PUB, the EK_PUB_CERT, and some other information. The PCA verifies the credentials by first decrypting the bundle using PCA_PRIV, verifies that the EK_PUB for that TPM is on its list, and returns an AIK_PUB_CERT certificate to the platform that has been encrypted with EK_PUB (the AIK_PUB_CERT is signed by PCA_PUB).

Remote Attestation: At the start of the remote attestation protocol, the MIEP platform holds the EK pair, the EK_PUB_CERT, the AIK pair, the AIK_PUB_CERT, and the PCA_PUB. Although the PCA holds the PCA pair, the EK_PUB, and the EK_PUB_CERT, it is not involved after the AIK certificate is generated. The challenger holds the PCA_PUB and the EK_PUB.

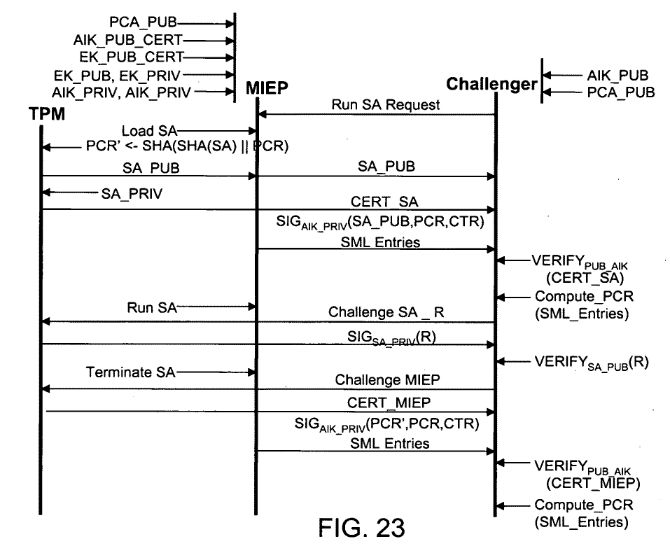

An example of an attestation protocol is diagrammed in FIG. 23. The protocol starts with a challenger requesting, for example, a Secure Application (SA) be run on the MIEP. The MIEP responds by loading the SA, the MIEP RTM (Root of Trust for Measurement) hashes the SA, and the MIEP RTS (Root of Trust for Storage) sends the hash result to the TPM to be appended/digested to the PCR to create PCR′, and the hash result is also stored in the SML (Stored Measurement Log). The SA creates a public/private key pair and sends the public part to the TPM. Now the TPM certifies the credentials to be delivered to the challenger using the AIK_PRIV part of the AIK key pair certified by the PCA. The credentials include the SA_PUB key, the current PCR value, and a Nonce or monotonic counter value (to prevent replay attacks). The challenger validates the credentials using the PUB_AIK key and then recomputes the PCR digest from the SML values to compare against PCR and also compares the hash of SA against an expected value. The MIEP now runs the SA. The challenger can issue a challenge to the SA using some random value, and the MIEP responds by signing the number with the SA_PRIV key. The challenger can then validate the signature using the SA_PUB key to verify that the correct SA is running. Upon SA termination, the challenger can challenge the MIEP again to determine that the software environment did not change during the execution of SA. Note that if any software is loaded into the environment by the MIEP, the RTM will recomputed the digest and store a new PCR′.

VIII.A.3 Direct Anonymous Attestation

A weakness with the use of a Privacy Certification Authority (PCA) to certify an AIK is that the third party may not in fact be trusted and that it is also possible to associate AIKs with a given device. To address this shortcoming the TCG has adopted a protocol known as Direct Anonymous Attestation (DAA) that is a group signature where the signature cannot be opened—and anonymity is not revocable.

Detractors of this type of group signature approach point out that if it is broken—it will be broke everywhere—a weakness of this type of approach that was made painfully public when the Content Scrambling System (CSS) was cracked. This weakness is known as BORE (Break Once, Run Everywhere).

### VIII.B. Platform Independence—Ability to Migrate Virtual Machines

Mobility is more than just about the ability to work and access resources and information when mobile. It is also about the ability to migrate work environments. The ability to migrate a complete environment (virtualized environment) between platforms is very powerful, particularly where at least one of the platforms is mobile and where the communications channel is wireless. Such a capability is facilitated by using a VMM model.

The MTM reduces mobility to its core essence of a mobile Root of Trust, a minimal portable repository of personal identity and Trust that is capable of leveraging a variety of hosts to access the internet using security based mechanisms to extend a Trusted Environment to the host.

### VIII.C. Platform Use of Meta-Data

Meta-data, that is, information about the nature of a given data, has been used in software engineering to provide capabilities for delayed declarations (common being use of reflection in Java). Meta-data can also be used for conveying contextual or environmental knowledge to a system. For instance, an operating system can be aware of memory performance issues being based by the cache/paging subsystem, or processor slowdown/shutdown. Meta-data has also been used in adaptively controlling transcoding of video data for energy efficient mobile devices. In another aspect of the invention, meta-data is used for contextual awareness such as the following elements:
1. A framework for declaring, attaching, updating meta-data that allows us to use it for feedback (back-annotation) and/or for composition (e.g., radio and processor meta-data);
2. Secure capture of the location information as a meta-data that can also be differentiated on security levels (e.g., the meta-information is available only at the link layer or transport layer thus preventing spoofing at the application layer). This can be significant since location information such as NMEA sentences from GPS are easily spoofed by the application;
3. Use of meta-data by the virtual machine monitor for coordinating processing and communication resources. For instance, by virtualizing radios for use across various VMs, the information on radio usage by individual VMs can be communicated in a radio-independent manner across the VMs and aggregated at the communications agent.

### VIII.D. Example Uses of the MIEP Trust Capabilities

VIII.D.1. Remote Provisioning

The ability to reliably, securely, and remotely provision MIEPs they are managing is crucial for both Enterprise and cellular Carriers. For Carriers, the driving needs include:
1) Reliable support for Over the Air (OTA) software updates
2) Maintaining network security and preventing denial of service attacks
3) Reliable user authentication
4) Creating secure environments to support value added services such as financial transactions

For Enterprise, the driving needs include:
1) Supporting secure corporate network access
2) Reliable user authentication
3) Supporting lost data destruction and other data security measures
4) Supporting computing environments for contractors that meet data security and regulatory requirements.
5) Secure hosting environments for corporate virtual desktops and terminal clients
6) Secure hosting environments for push data environments

Aspects of the invention significantly improves the ability of Enterprise IT departments and Carriers to meet these needs as, by virtue of the HROT, trusted boot, and integrity measurement and attestation capabilities they can be assured that the MIEP is in a known good state, and that secure trusted paths exist for user input to support reliable authentication and user I/O. Furthermore, the remote provisioning entity can create separate strongly isolated environments on the MIEP, by using VMs on the MIEP, that are individually provisionable and attestable, thus providing the provisioning entity with a great deal of flexibility in Endpoint management and configuration.

VIII.D.2 Applications

Existing mobile internet Endpoints that claim to offer high security typically achieve that security via a closed platform. However, as the market moves towards open platforms, spurred by open networks, more complex operating systems, the ability to download and install arbitrary applications, and with end users using their personal Endpoints for corporate purposes, aspects of the invention offer a method of achieving typically better than closed platform security on an open platform.

Significant effort is being expended in the Enterprise to support, centralized client/server computing, most recently in a form known as server based desktop virtualization. However, this approach has a number of drawbacks:
1) It does not take best advantage of the continued decrease in cost and increase in functionality in MIEPs
2) Users typically experience long boot times
3) The user experience is dependent on the network bandwidth
4) Difficulty in supporting rich media types because of the network bandwidth required
5) Loss of worker productivity when not connected to the network.

Two important reasons typically cited as to why the Enterprise does not place greater emphasis on Endpoint based desktop virtualization as an alternative are provisioning and security. Both of these Endpoint issues are addressed by aspects of the invention, enabling Endpoint based desktop virtualization to become a predominant Enterprise mobile computing paradigm.

Some example applications, and how they would be enabled by various aspects of the invention, are highlighted below:

Secure Terminal Client Hosting. A VM that is provisioned to be “locked down” on the MIEP, such as the locked down VM in FIG. 21, can be used to host a secure Terminal Client for access to Enterprise networks. This VM is strongly isolated from the other VMs, so cannot be compromised by a VM that has become infected by malware.

Secure MIEP Based Desktop Virtualization. Similar to the Terminal Client hosting example above, a strongly provisioned “locked down” VM on the MIEP can be used to host an Endpoint based desktop virtualization system.

Secure Push Data Hosting. Secure push email, calendar, and contact lists are the staple of Enterprise mobile Endpoint functionality, and typically the security of those push applications is via closed platforms. Aspects of the invention offer the opportunity of obtaining the “security of a closed platform on an open platform” through the HROT, trusted boot process, and integrity measurement capabilities to host push data applications on the MIEP.

Secure Autonomous Lost Data Destruction. With a HROT and trusted boot process, the MIEP is capable of reliable erasure of lost data on an autonomous basis, i.e. the data wipe does not require connection to the internet for the wipe to be initiated and logged by the IT department. IT can be confident that the data has been wiped, or safely sequestered via encryption, based on policies set on the MIEP.

The data wipe can be initiated on the MIEP based on policies, such as requiring that the MIEP “phone home” on a periodic basis, and if that is not achieved, initiate the data wipe of sensitive data.

### VIII.E. Dynamic Attestation

Attestation, as defined by the TCG, is “the process vouching for the accuracy of information”. Attestation can take various forms—also defined by the TCG to be:
1. Attestation by the HROT (the TPM)—an operation providing proof of data known to the TPM.
2. Attestation to the platform—an operation that provides proof that a platform can be trusted to report integrity measurements.
3. Attestation of the platform—an operation that provides proof of a set of the platform's integrity measurements.
4. Authentication of the platform—providing evidence of a claimed identity.

In the discussion below we use the terms verify and verification to mean an operation that is used to measure the validity or trustworthiness of a particular component of the system, which in turn can generally be viewed of as a step in an attestation process.

Current trusted boot models, represented by the trusted boot procedure outlined by the TCG (http://www.trustedcomputinggroup.org) take a fairly static view of the attestable state. That is, only the state of the system immediately after boot can typically be attested. But the system state may change with execution with the loading of dynamically linked libraries, modifications to the Windows registry, etc. Thus the system can drift from the initial attested state, and verification becomes less reliable and attestation more difficult. Thus “one time” existing trusted boot and the resultant attestation models limits the use of attestation in real world situations. A method is needed to extend attestation techniques to deal with the dynamic changes in the system state.

One approach is to run verifications in the background as the system state evolves, and “cache” results either by extending the PCR registers directly in the HROT or by storing verification results in sealed storage (“blobs”). While this may work, it leads to very high resource utilization, thus limiting its use on a sufficiently continuous basis. Furthermore, attestations become more time consuming as the number of extensions to the PCRs and the resulting attestation chains grow. A method is needed to extend attestation to cope with execution state mutation that does not require a significant attestation compute burden.

We introduce a concept called “dynamic attestation” that extends the attestation model through the software hierarchy from the BIOS to the application level while adhering to the general “trust ratcheting” principal inherent in the TCG based use of the PCRS. Encrypted, or sealed storage can be utilized to extend the PCR model to each level in the hierarchy, so that any and all levels, including applications, can be verified independently from one-another. They can be sealed against the entire ratchet chain beneath a particular level, or just against the invariant component of that level. We call these typically encrypted or sealed extensions of the PCR ECRs (“Extended Configuration Registers”).

Dynamic attestation operates at a finer granularity that standard models and deals with mutating state using a layered approach. This enables it to make the verification process incremental and computationally less burdensome.

To achieve dynamic attestation, we make a distinction between invariant and modifiable state. Invariant state information is useful in reducing the size of the verification task. We also architect the system to leverage “packaged and verified” software entities where possible to maximize system robustness. This is a hard problem in practice, particularly for the Windows environment, since it is difficult to create cleanly packaged and verified software modules. We note that VMs themselves, when first instantiated, are good examples of such “packaged and verified” entities.

Important modifiable state areas to consider include memory allocation/deallocation, the execution stacks, and the registry.

The system designer can make distinctions among modifiable state, including:
1. The state, if modified, cannot result in malicious behavior
2. The state, if modified, can result in malicious behavior—which can be dealt with by approaches such as:
   a. Ignoring it, knowing that malicious behavior cannot extend to other VMs, relying on other isolation mechanisms, or knowing the malicious behavior cannot survive an attestable re-instantiation of the VM environment and/or application
   b. Encrypting the state
   c. Constantly verifying correct behavior (behavioral monitoring)

The keys for encrypted state can be stored in the TPM, encrypted and stored elsewhere in the system, or preferably as sealed blobs that can be sealed against aspects of the system, including the invariant state of the current software level, or against the attestation state of the software stack up to that level.

To minimize computation, the allocated memory can be brought into and out of RAM in large chunks to minimize encryption/decryption overhead. To reduce tampering and memory/TLB attacks, the VMM should ensure that those chunks are isolated in RAM.

Stack state is more challenging to protect. It is unreasonable to expect that an application stack can be effectively verified as a block of memory because specific aspects of the stack are nondeterministic and contain information such as specific hardware and memory addresses that will change from system to system and even from execution to execution within the same system. However portions of the stack that are volatile still remain predictable such that, “scrubbed” stack trace data, that is abstracted or simplified representations of the stack, can be conditionally verified at principle functional checkpoints. This provides protection from certain types of semantec attacks such as library substitutions and malicious plug-ins and components, since only certain program execution flows are allowed through known signed libraries, plug-ins, and components. Furthermore, the ability for a program to support stack state validation need not require explicit coding by the application. Since the nature of the execution stack is to store the function or method call history, a validation tool could link in bindings to validation routines so that a PCR measurement may be extended according to some scheme. This allows for the program to take measurements and validate stack state at specified stack locations with no additional programming.

We briefly discuss each level in the software hierarchy:

BIOS: The BIOS is considered invariant. It is usually a RTMS (Root of Trust for Measurement). Access to the BIOS is protected/controlled.

VMM: The VMM itself is readily attestable at any time as it is invariant to change, except principally for some state information associated with the VMs it is hosting, and this state information can easily be protected as sealed storage (blobs).

VM: VMs can be “packaged” as verifiable and attestable state for instantiation, and in general all VM instantiations can be realized as such.

Operating System: OS images can be “packaged” as verifiable at attestable state for instantiation, and for certain applications a “clean” OS image is appropriate. But in general OS image state will mutate and one or more of the dynamic attestation techniques mentioned above will be applied.

Application: Like OS images, application images can be “packaged” as verifiable at attestable state for instantiation, and in most instances a “clean” OS image is appropriate (with user preferences being the only state that typically mutates). In the cases where application image state will mutate and one or more of the dynamic attestation techniques mentioned above will be applied.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

1. A trusted virtualization system comprising a trustworthy mobile endpoint device, the mobile endpoint device comprising:
a communications module that provides a communications link between the mobile endpoint device and a networked infrastructure;
a host processor and memory;
a hardware based tamper-resistant module (hereafter, the hardware root of trust or HROT), the HROT comprising:
secure non-volatile memory for storing integrity measurement data and data related to keys,
a computational module;
a key pair generation module, and
a random number generator;
a trusted boot process executed by the host processor to boot the mobile endpoint device into a known state, the trusted boot process utilizing the HROT to provide cryptographic resources and secure non-volatile memory to verify the integrity of the mobile endpoint device;
an attestation process executed by the host processor to attest to the integrity of the mobile endpoint device in response to an attestation challenge, the attestation process utilizing the HROT to provide integrity measurements of the mobile endpoint device, said integrity measurements verifying an integrity of a state of the mobile endpoint device;
a Type-1 trusted virtual machine monitor (hereafter, the Type-1 TMM) that executes on the host processor, the trusted boot process including booting of the Type-1 TVMM and utilizing the HROT to verify the integrity of the Type-1 TVMM, the Type-1 TVMM capable of hosting a plurality of virtual machines and virtualizing the HROT independently for each such hosted virtual machine.

2. The virtualization system of claim 1 wherein the attestation process can attest to a specific virtual machine independent of other virtual machines hosted by the mobile endpoint device, the attestation process utilizing the HROT to provide integrity measurements of layers in the hardware and software stack that are required for correct operation of the specific virtual machine.

3. The virtualization system of claim 2 wherein the virtual machines can host operating systems and the attestation process can attest to a specific operating system independent of other operating systems hosted by the mobile endpoint device, the attestation process utilizing the HROT to provide integrity measurements of layers in the hardware and software stack that are required for correct operation of the specific operating system.

4. The virtualization system of claim 3 wherein the virtual machines can host operating systems, the operating systems can host applications, and the attestation process can attest to a specific application independent of other applications hosted on the mobile endpoint device, the attestation process utilizing the HROT to provide integrity measurements of layers in the hardware and software stack that are required for correct operation of the specific application.

5. The virtualization system of claim 1 wherein the networked infrastructure comprises an agent server communicating with the mobile endpoint device over a communications channel that includes the communications link, the agent server comprising:
a virtual machine monitor hosted by the agent server, the virtual machine monitor capable of hosting virtual machines on behalf of the mobile endpoint device.

6. The virtualization system of claim 5 wherein the agent server further comprises:
a host processor and memory, the virtual machine monitor executing on the host processor;
an HROT comprising:
secure non-volatile memory for storing integrity measurement data and data related to keys,
a computational module,
a key pair generation module, and
a random number generator;
a trusted boot process executed by the host processor to boot the server into a known state, the trusted boot process utilizing the HROT to provide cryptographic resources and secure non-volatile memory to verify the integrity of the mobile endpoint device;
an attestation process executed by the host processor to attest to an integrity of the server in response to an attestation challenge received from the mobile endpoint device, the attestation process utilizing the HROT to provide integrity measurements of the server, said integrity measurements verifying an integrity of a state of the server; and
the virtual machine monitor capable of hosting a plurality of virtual machines (including virtual machines hosted on behalf of the mobile endpoint device) and virtualizing the HROT independently for each such hosted virtual machine.

7. The virtualization system of claim 6 wherein, on the agent server, the attestation process can attest to a specific virtual machine hosted on behalf of the mobile endpoint device independent of other virtual machines hosted by the agent server, the attestation process utilizing the HROT to provide integrity measurements of layers in the hardware and software stack that are required for correct operation of the specific virtual machine.

8. The virtualization system of claim 6 wherein, on the agent server, the virtual machines can host operating systems and the attestation process can attest to an operating system hosted on the virtual machine hosted on behalf of the mobile endpoint device independent of other operating systems hosted by the agent server, the attestation process utilizing the HROT to provide integrity measurements of layers in the hardware and software stack that are required for correct operation of said operating system.

9. The virtualization system of claim 6 wherein, on the agent server, the virtual machines can host operating systems, the operating systems can host applications, and the attestation process can attest to a specific application hosted on the virtual machine on behalf of the mobile endpoint device independent of other applications hosted on the agent server, the attestation process utilizing the HROT to provide integrity measurements of layers in the hardware and software stack that are required for correct operation of the specific application.

10. The virtualization system of claim 5 wherein the mobile endpoint device can spawn virtual machines hosted by the agent server.

11. The virtualization system of claim 10 wherein the agent server can spawn virtual machines hosted by the mobile endpoint device.

12. The virtualization system of claim 11 wherein the agent server can stipulate a set of policies through the virtual machines spawned by the agent server on the mobile endpoint device.

13. The virtualization system of claim 10 wherein the mobile endpoint device can spawn agent applications hosted by virtual machines hosted by the agent server.

14. The virtualization system of claim 13 wherein the agent application is an anti-malware application that scans data prior to said data being transferred to the mobile endpoint device.

15. The virtualization system of claim 13 wherein the agent application is a behavioral monitoring agent that receives signatures from the mobile endpoint device of the execution behavior of the mobile endpoint device and uses said signatures to determine a health state of the mobile endpoint device.

16. The virtualization system of claim 13 wherein the agent application is a web browsing anonymization agent that assists the mobile endpoint device to retain anonymity while the mobile endpoint device browses the web.

17. The virtualization system of claim 13 wherein the agent application is a P2P proxy for a P2P client application, where the P2P client functionality is partitioned between the mobile endpoint device and the P2P proxy, the P2P proxy supporting upstream forwarding bandwidth requirements of a P2P network, said P2P proxy forwarding P2P downstream data to the mobile endpoint device and forwarding P2P upstream data to requesting peers in a P2P swarm.

18. The virtualization system of claim 13 wherein the agent application is a web filtering content agent that removes unwanted web page content before the web page is transmitted to the mobile endpoint device.

19. The virtualization system of claim 13 wherein the agent application is a data compression agent that compresses data before transmission to the mobile endpoint device.

20. The virtualization system of claim 13 wherein the agent application is a data storage agent that manages web based data storage for the mobile endpoint device.

21. The virtualization system of claim 13 wherein the agent application is a transaction proxy that is authorized to act on behalf of the mobile endpoint device to manage transactions.

22. The virtualization system of claim 13 wherein the agent application is a communications channel virtualization agent that coordinates a virtualization of multiple communications channels between the mobile endpoint device and the agent server into a single virtual communications channel.

23. The virtualization system of claim 13 wherein the agent application is a single sign-on agent that serves as a web identity broker to manage various user web identities and authentication information to create a personal secure virtual web SSO (Single Sign On) service.

24. The virtualization system of claim 13 wherein the agent application adjusts its functionality based on contextual awareness of the state of the mobile endpoint device.

25. The virtualization system of claim 13 wherein the agent application adjusts its functionality based on a bandwidth of the communications channel between the mobile endpoint device and the agent server.

26. The virtualization system of claim 13 wherein the agent application adjusts its functionality based on a latency of the communications channel between the mobile endpoint device and the agent server.

27. The virtualization system of claim 13 wherein the agent application adjusts its functionality based on a usage cost of the communications channel between the mobile endpoint device and the agent server.

28. The virtualization system of claim 13 wherein the agent application adjusts its functionality based on an energy status of the mobile endpoint device and/or energy use cost of the agent application.

29. The virtualization system of claim 13 wherein the agent application adjusts its functionality based on memory availability on the mobile endpoint device.

30. The virtualization system of claim 13 wherein the agent application adjusts its functionality based on a past location and/or time of past location of the mobile endpoint device and also based on current location and current state of the mobile endpoint device.

31. The virtualization system of claim 10 wherein the mobile endpoint device can stipulate a set of policies through the virtual machines spawned by the mobile endpoint device on the agent server.

32. The virtualization system of claim 31 wherein the set of policies includes a policy on permissible I/O modalities.

33. The virtualization system of claim 31 wherein the set of policies includes a policy on which URLs or web sites may be accessed by the mobile endpoint device.

34. The virtualization system of claim 31 wherein the set of policies includes a policy on permissible applications.

35. The virtualization system of claim 31 wherein the set of policies includes a policy on when and/or where certain applications may be executed.

36. The virtualization system of claim 5 wherein the mobile endpoint device has a capability to clone a virtual machine hosted by the Type-1 TVMM and also operating system(s) and application(s) hosted on the virtual machine, and the mobile endpoint device further has a capability to transfer the clone to the agent server as an executable template for execution on behalf of the mobile endpoint device.

37. The virtualization system of claim 36 wherein the executable template further includes integrity measurements of the cloned virtual machine, operating system(s) and application(s).

38. The virtualization system of claim 5 wherein the mobile endpoint device has a capability to clone a virtual machine hosted by the Type-1 TVMM and also operating system(s) and application(s) hosted on the virtual machine, and the mobile endpoint device further has a capability to transfer the clone to the agent server as a honeypot clone to test software or content destined for the mobile endpoint device for malware or malicious behavior before said software or content is transferred to the mobile endpoint device.

39. The virtualization system of claim 1 wherein a past location history and/or times of past locations of the mobile endpoint device is used as a factor in a multi-factor user authentication process.

40. The virtualization system of claim 1 wherein the Type-1 TVMM collects aggregate meta-data that cannot be associated with any particular virtual machine, the meta-data characterizing a behavior and/or performance of virtualized resources used by the mobile endpoint device, the meta-data available to the virtual machines hosted by the Type-1 TVMM and to applications hosted by said virtual machines.

41. The virtualization system of claim 1 wherein the mobile endpoint device further comprises:
a display framebuffer, a portion of which is controlled by the Type-1 TVMM to indicate a trust level of the mobile endpoint device.

42. The virtualization system of claim 41 wherein the mobile endpoint device further comprises:
a multi-windowed environment, wherein the Type-1 TVMM can lock down a cursor and keyboard focus to a specific window.

43. The virtualization system of claim 41 wherein the portion of the display framebuffer controlled by the Type-1 TVMM further indicates a trust level of a virtual component executing on an agent server in the networked infrastructure on behalf of the mobile endpoint device.

44. The virtualization system of claim 1 wherein the communications link is a wireless communications link.

45. The virtualization system of claim 1 wherein the networked infrastructure includes the Internet.

46. A mobile trust module comprising:
a first standard connector for connecting the mobile trust module to a mobile endpoint device;
a hardware based tamper-resistant module (hereafter, the hardware root of trust or HROT), the HROT comprising:
secure non-volatile memory for storing integrity measurement data and data related to keys,
a computational module,
a key pair generation module,
a random number generator;
a trusted boot process that boots the mobile endpoint device into a known state, the trusted boot process utilizing the HROT to provide cryptographic resources and secure non-volatile memory to verify the integrity of the mobile endpoint device;
an attestation process to attest to an integrity of the mobile endpoint device in response to an attestation challenge received by the mobile endpoint device, the attestation process utilizing the HROT to provide integrity measurements of the mobile endpoint device, said integrity measurements verifying an integrity of a state of the mobile endpoint device;
a Type-1 trusted virtual machine monitor (hereafter, the Type-1 TVMM), the trusted boot process including booting of the Type-1 TVMM onto the mobile endpoint device and utilizing the HROT to verify an integrity of the Type-1 TVMM, the Type-1 TVMM capable of hosting a plurality of virtual machines and virtualizing the HROT independently for each such hosted virtual machine.

47. The mobile trust module of claim 46 wherein the first standard connector is a USB connector.

48. The mobile trust module of claim 46 wherein the first standard connector is a Secure Digital (SD) connector.

49. The mobile trust module of claim 46 wherein the first standard connector is an SDIO connector.

50. The mobile trust module of claim 46 wherein the first standard connector is a MiniSD connector.

51. The mobile trust module of claim 46 wherein the first standard connector is a MicroSD connector.

52. The mobile trust module of claim 46 further comprising:
a second standard connector of a same type but opposite polarity as the first standard connector, allowing pass through of signals from the second standard connector to the first standard connector.

53. The mobile trust module of claim 46 further comprising:
a physical user control, activation of which initiates the trusted boot process.

54. The mobile trust module of claim 46 further comprising:
a human perceptible indicator that indicates a trust level of the mobile endpoint device.

55. The mobile trust module of claim 54 wherein the human perceptible indicator indicates whether the trusted boot process and/or verification of integrity of the state of the mobile endpoint device has been successfully completed.

56. The mobile trust module of claim 54 wherein the human perceptible indicator indicates when the trusted boot process and/or verification of integrity of the state of the mobile endpoint device is in process.

57. The mobile trust module of claim 54 wherein the human perceptible indicator indicates whether the trusted boot process and/or verification of integrity of the state of the mobile endpoint device has failed or has not been initiated.

58. The mobile trust module of claim 46 wherein, prior to initiation of the trusted boot process from the mobile trust module onto the mobile endpoint device, a current state of the mobile endpoint device is stored for possible later restoration.

59. The mobile trust module of claim 46 further comprising:
anti-malware software that performs an anti-malware scan of the mobile endpoint device prior to initiation of the trusted boot process from the mobile trust module onto the mobile endpoint device.

60. The mobile trust module of claim 46 wherein the HROT further comprises a real-time clock.
